(19) United States
(12) Patent Application Publication
(10) Pub. No.: US 2026/0343141 A1
(43) Pub. Date: Oct. 29, 2026

(54) FACE-MOUNTED DISPLAY DEVICE

(71) Applicant: LG ELECTRONICS INC., Seoul (KR)

(72) Inventors: Hyukjae LEE, Seoul (KR); Donghyun KIM, Seoul (KR); Junsuk LEE, Seoul (KR)

(73) Assignee: LG ELECTRONICS INC., Seoul (KR)

(21) Appl. No.: 19/109,075

(22) PCT Filed: Sep. 8, 2022
(86) PCT No.: PCT/KR2022/013575

§ 371 Date: Mar. 5, 2025

(51) Int. Cl. H04R 1/34; G02B 27/01; H04R 1/02; H04R 1/06

(52) U.S. Cl. CPC H04R 1/345; G02B 27/0176; H04R 1/025; H04R 1/06; G02B 2027/0152; H04R 2499/11

(57) ABSTRACT

Disclosed is a face-mounted display device. A temple of the face-mounted display device has: a speaker accommodation part formed to accommodate a speaker at the rear end thereof; and speaker holes spaced apart by preset distances from the speaker accommodation part and located in front of the ears of a user. The speaker accommodation part and the speaker holes are connected in communication with each other. Therefore, the size of the temple is reduced, and the user can hear sound from the speaker clearly.

### TECHNICAL FIELD

The present disclosure relates to a face-mounted display device.

### BACKGROUND ART

Terminals may be classified as glass-type terminals (mobile/portable terminals) and stationary terminals depending on mobility. The glass-type terminals may be further divided into handheld terminals and vehicle-mounted terminals depending on whether a user can carry the glass-type terminals directly.

As functions of such terminals diversify, the terminals are being implemented in a form of multimedia devices (multimedia players) having composite functions such as photo or video capturing, playback of music or video files, gaming, and broadcasting reception.

Recently, wearable-type glass-type terminals configured to be mountable on a part of a human body are being developed.

Glass-type terminals mounted on a face of a user may largely correspond to a head-mounted display (virtual reality implementation) and AR glasses (augmented reality implementation).

A display unit included in such glass-type terminals may be combined with augmented reality technology, N-screen technology, etc. beyond simple video output functions to provide various conveniences to the user.

However, among face-mounted display devices in the related art which are mounted on a head of a user, when a speaker is located in front of an ear, such a problem that a size of a temple is increased due to a size of the speaker occurs. In addition, when sound output from a speaker is located in rear of an ear of a user, there is a problem in that sound output together with an image is not clearly delivered to the user. In addition, there is such a problem that small wearable devices have a structural problem in securing sufficient back volume. Furthermore, since a display unit that outputs an image and a battery that supplies power are placed at a front of a head, there is a problem that the face-mounted display device is tilted toward a front of the head, and thus, is uncomfortable to wear for long periods of time.

### DISCLOSURE OF INVENTION

### Technical Problem

Therefore, an objective of the present disclosure is to provide a face-mounted display device in which a speaker is disposed in a rear of a temple and sound from the speaker is output in front of an ear of a user to thereby deliver the sound to the user clearly while reducing a size of the temple.

Another objective of the present disclosure is to provide a face-mounted display device capable of securing sufficient back volume and distributing a weight evenly to a front side and a rear side of a head.

### Solution to Problem

The above-described objectives of the present disclosure are achieved as described below.

A face-mounted display device according to embodiments of the present disclosure includes a body, a temple, and a speaker. The body is disposed to correspond to eyes of a user. The temple has a front end portion connected to the body and a rear end portion disposed at a rear of an ear. The speaker is equipped in the temple. In addition, the temple includes a speaker accommodation part disposed to accommodate the speaker in the rear end portion, and a speaker hole spaced apart from the speaker accommodation part by a preset distance and disposed in front of the ear. The speaker accommodation part and the speaker hole are connected in communicate with each other. Since the speaker holes are located in front of the ear of a user, the user may hear sound emitted from the speaker hole more clearly.

In one embodiment of the present disclosure, the temple includes a sound pressure conduit part that connects the speaker accommodation part to the speaker hole in communication with each other, and a wire accommodation part partitioned from the sound pressure conduit part.

In detail, the temple includes an inner temple disposed inside, and an outer temple engaged with the inner temple and disposed outside. The sound pressure conduit part and the wire accommodation part are defined and separated by combining the inner temple and the outer temple.

In detail, each of the inner temple and the outer temple includes a first section extending in one direction, and a second section extending from the first section in a direction other than the one direction.

In detail, each of the inner temple and the outer temple includes a base having a plate shape and configured as the first section and the second section, a side wall protruding along an edge of the base in a thickness direction, and an inner partition wall protruding from an inner surface of the base and configured to have a preset length.

In detail, the sound pressure conduit part is partitioned from the wire accommodation part by the inner partition wall. The sound pressure conduit part is an inner space surrounded by the inner partition wall and a lower wall of the temple. In addition, the speaker hole is connected in communication with the sound pressure conduit part, and disposed on a lower wall of the first section.

In detail, the second section of the outer temple includes the speaker accommodation part disposed on an outer surface, a speaker accommodation part hole disposed through the speaker accommodation part, and a back volume hole disposed through a position spaced apart from the speaker accommodation part by a preset distance. The speaker accommodation part is connected in communication with the sound pressure conduit part by the speaker accommodation part hole. The back volume hole is connected in communication with the wire accommodation part. Accordingly, the wire accommodation part has an effect of expanding volume of back volume.

In detail, the face-mounted display device in the present disclosure includes a speaker cover that covers the speaker accommodation part and the back volume hole.

In another embodiment of the present disclosure, each of the inner temple and the outer temple includes a base having a plate shape with a preset length in one direction, a side wall protruding along an edge of the base in a thickness direction, and an inner partition wall protruding from an inner surface of the base and configured to have a preset length.

In detail, the sound pressure conduit part is partitioned from the wire accommodation part by the inner partition wall. The sound pressure conduit part is an inner space surrounded by a side wall in the rear end portion of the temple, the inner partition wall, and a lower wall of the temple. In addition, the speaker hole is connected in communication with the sound pressure conduit part, and disposed on the lower wall of the temple.

In detail, the outer temple includes the speaker accommodation part disposed on an outer surface, a speaker accommodation part hole disposed through the speaker accommodation part, and a back volume hole disposed through a position spaced apart from the speaker accommodation part by a preset distance. The speaker accommodation part is connected in communication with the sound pressure conduit part by the speaker accommodation part hole. The back volume hole is connected in communication with the wire accommodation part.

In still another embodiment of the present disclosure, the inner temple includes an inner base having a plate shape and configured as the first section and the second section, and a coupling groove disposed to be concave in a thickness direction along an edge of the inner base. In addition, the outer temple includes an outer base having a plate shape and configured as the first section and the second section, and a coupling protrusion part protruding in a thickness direction along an edge of the outer base and forced-fit into the coupling groove.

In detail, the sound pressure conduit part is formed to be spaced apart from the wire accommodation part by a preset distance. The sound pressure conduit part is formed to have a groove shape in the first section and the second section of the inner base to be connected in communication with each other. In addition, the wire accommodation part is formed to have a groove shape from a front end portion to a rear end portion of the inner base. The speaker hole is connected in communication with the sound pressure conduit part, and formed on a lower surface of the first section.

In detail, the second section of the outer temple includes the speaker accommodation part disposed on an outer surface, a speaker accommodation part hole disposed through the speaker accommodation part, and a back volume hole disposed through a position spaced apart from the speaker accommodation part by a preset distance. The speaker accommodation part is connected in communication with the sound pressure conduit part by the speaker accommodation part hole, and the back volume hole is connected in communication with the wire accommodation part.

The face-mounted display device according to embodiments of the present disclosure further includes a strip fixed to both ends of the temple. Accordingly, the face-mounted display device is firmly fixed to a head of the user.

In addition, the face-mounted display device according to embodiments of the present disclosure further includes a tension adjustment part coupled to the strip to adjust tension of the strip. Accordingly, the face-mounted display device may be worn by several users.

In addition, the face-mounted display device according to embodiments of the present disclosure further includes a battery disposed in the strip or the tension adjustment part. By having the battery located at a rear surface of the head of the user, a weight of the face-mounted display device may be evenly distributed in relation to the body placed on a face of the head.

In addition, the body of the face-mounted display device according to embodiments of the present disclosure includes glass placed in front of both eyes of the user. In addition, the temple includes a first temple connected to one side among both sides of the body and a second temple connected to another side among the both sides of the body. The first temple includes the sound pressure conduit part, the wire accommodation part, and a substrate accommodation part that accommodates a display device on a front end side. The second temple includes the sound pressure conduit part, the wire accommodating part, and a battery accommodation part that accommodates a battery on a front end side.

### Advantageous Effects of Invention

The face-mounted display device according to the present disclosure has an effect of reducing a size and a weight of a temple by placing a speaker in rear of the temple.

In addition, an effect of allowing sound output from a speaker to be delivered in front of ears of a user so that the user may clearly and distinctly hear the output sound along with an image is present.

In addition, an effect of expanding volume of back volume by using a wire accommodation part of a temple as back volume is present.

In addition, an effect of capable of distributing a weight of a device in the present disclosure evenly between a front and a rear of a head by placing a display module that outputs an image at the front of the head and a battery that supplies power in the rear of the head is present.

### BRIEF DESCRIPTION OF DRAWINGS

FIG. 1 is a front perspective view illustrating a face-mounted display device according to an embodiment of the present disclosure.

FIG. 2 is a rear perspective view illustrating the face-mounted display device of FIG. 1.

FIG. 3 is a side perspective view showing a user wearing the face-mounted display device of FIG. 1.

FIG. 4 is a side perspective view showing a user wearing the face-mounted display device of FIG. 1.

FIG. 5 is an exploded perspective view of the face-mounted display device of FIG. 1.

FIG. 6 is an exploded perspective view illustrating a first embodiment of a temple.

FIG. 7 is a perspective view illustrating a combining state of the temple of FIG. 6.

FIG. 8 is a perspective view illustrating an inner temple of FIG. 6.

FIG. 9 is a perspective view illustrating an outer temple of FIG. 6.

FIG. 10 is a perspective view illustrating the outer temple of FIG. 6 and a speaker cover.

FIG. 11 is an exploded perspective view illustrating a second embodiment of the temple.

FIG. 12 is a perspective view illustrating an outer temple of FIG. 11 and a speaker cover.

FIG. 13 is an exploded perspective view illustrating a third embodiment of the temple.

FIG. 14 is a cross-sectional view of a portion A-A of FIG. 13.

FIG. 15 is a cross-sectional view of a portion B-B of FIG. 13.

FIG. 16 is a perspective view illustrating an outer temple of FIG. 13 and the speaker cover.

FIG. 17 is a side perspective view showing a user wearing the temple of FIG. 6.

FIG. 18 is a cross-sectional view of a portion C-C of FIG. 17.

FIG. 19 is a cross-sectional view of a portion B-B of FIG. 17.

FIG. 20 is a perspective view illustrating a temple connection part of the face-mounted display device of FIG. 1.

FIG. 21 is an exploded perspective view of the temple connection part of FIG. 20.

FIG. 22 is a front view of a strip and a tension adjustment part of FIG. 21.

FIG. 23 is a rear perspective view of FIG. 22.

FIG. 24 is a perspective view illustrating a strip and a gear accommodation part each shown in FIG. 21.

FIG. 25 is a perspective view illustrating the gear accommodation part of FIG. 24.

FIG. 26 is a front exploded perspective view illustrating the tension adjustment part of FIG. 21.

FIG. 27 is a rear exploded perspective view illustrating the tension adjustment part of FIG. 21.

FIG. 28 is one side view of AR glass.

FIG. 29 is another side view of the AR glass.

FIG. 30 illustrates a body of the AR glass.

### MODE FOR THE INVENTION

Hereinafter, embodiments of the present disclosure will be described in detail with reference to the accompanying drawings. In the description of the present disclosure, certain detailed explanations that may be clearly understood and easily reproduced by a person of ordinary skill in the art in view of the related art are omitted when it is deemed that they may unnecessarily obscure the essence of the present disclosure.

A face-mounted display device (a face display device) described in this specification includes a head mounted display (HMD) that generally implements virtual reality and AR glasses that generally implement augmented reality.

Hereinafter, a face-mounted display device (a face display device) according to embodiments of the present disclosure will be described.

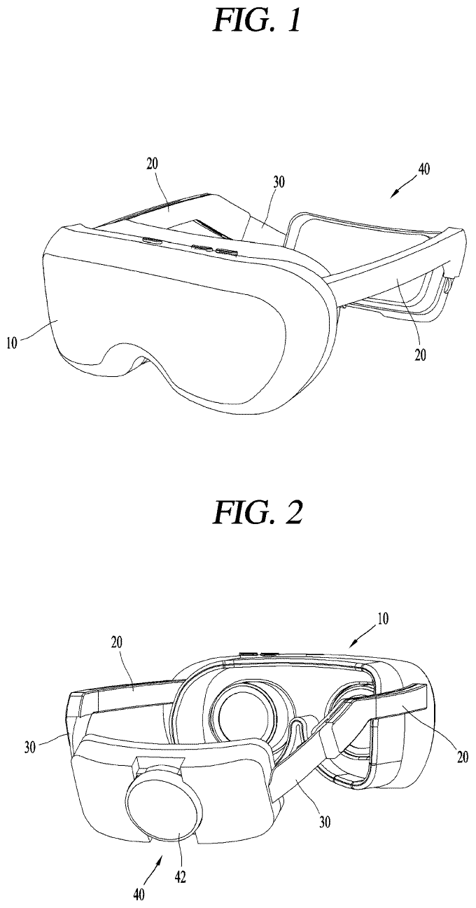

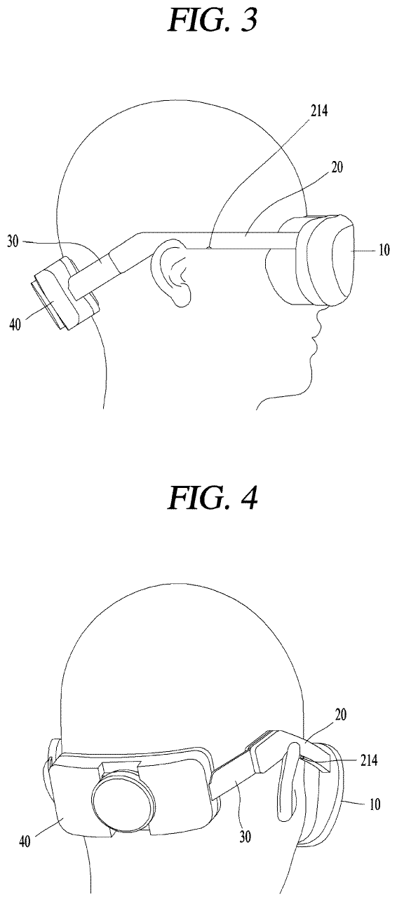

Referring to FIGS. 1 to 5, a face-mounted display device according to one embodiment of the present disclosure includes a body 10 positioned to correspond to eyes of a user, a temple 20 connected to the body 10, and a speaker 50 disposed in the temple 20.

The body 10 is placed at a position corresponding to the eyes of the user on a face of the user. Here, the face represents a front surface of head on which the eyes, a nose, and a mouth are present.

The body 10 has a display module that outputs an image and a body case that accommodates the display module.

The display module has a PCB assembly 13 including a camera and a display-lens assembly 12 electrically connected to the PCB assembly 13.

A display method by which the display module performs displaying inside the body 10 is identical or similar to a display method performed by a head-mounted display in the related art. Thus, a detailed description thereof is not provided here.

The body case has a front body case 14 that accommodates the display module at front, and a rear body case 11 that is connected to the front body case and accommodates the display module at a rear.

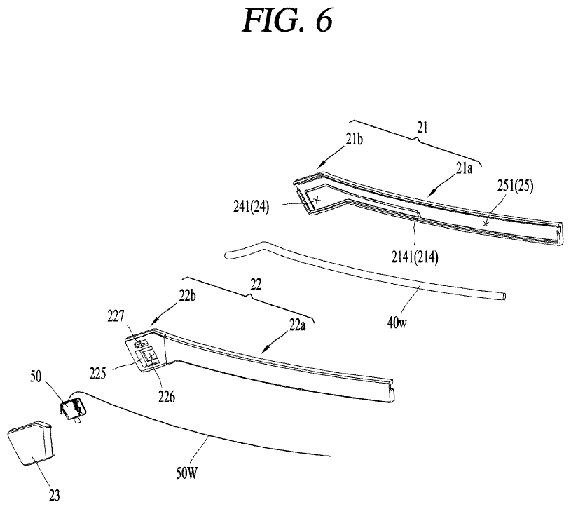

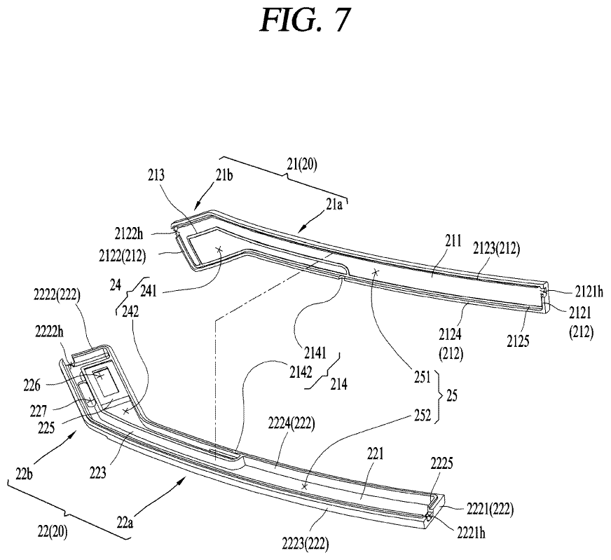

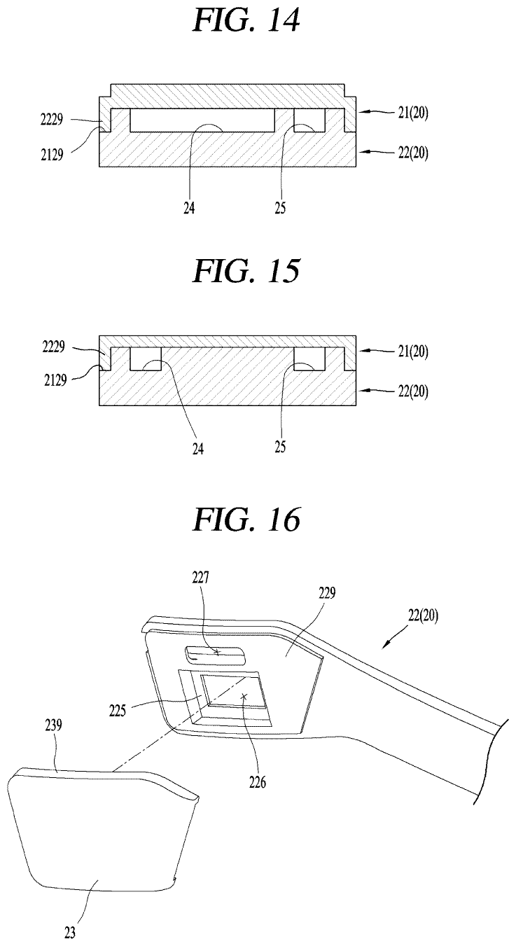

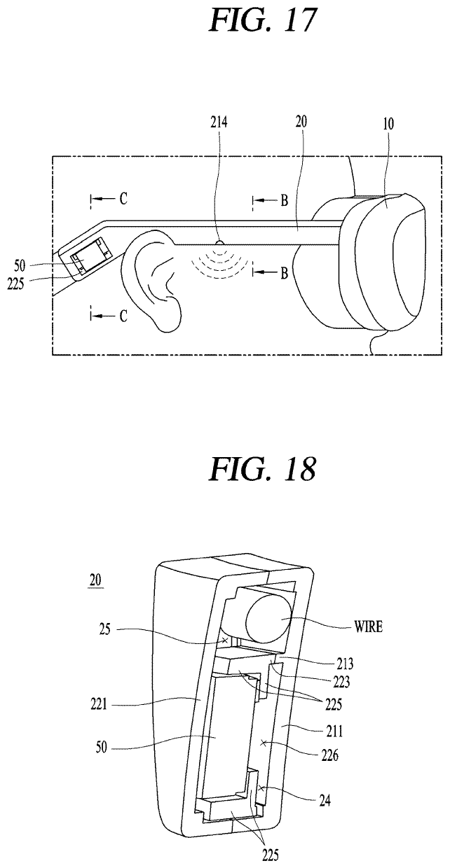

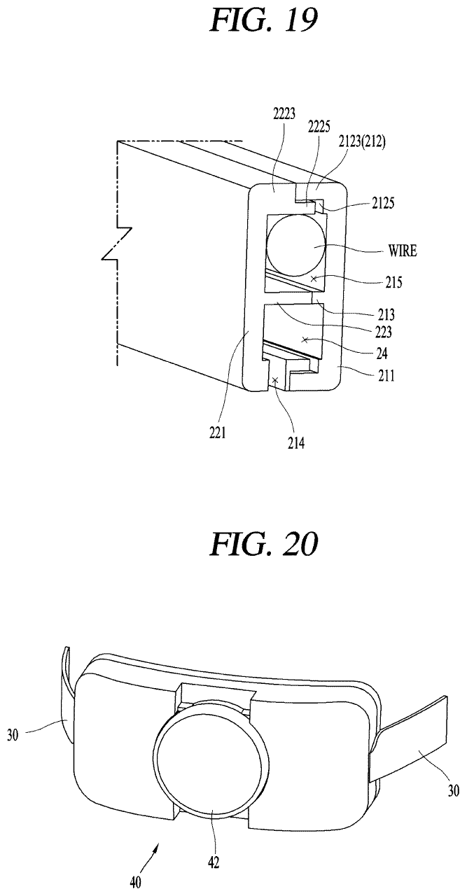

Referring to FIGS. 6 to 19, when a user wears the face-mounted display device in the present disclosure on a head of the user, the temple 20 comes into contact with the head and/or ears of the user and supports the body 10.

The temple 20 is connected to each of both end portions (or both sides) of the body 10.

The temple 20 includes both end portions. In detail, the temple 20 includes a front end portion connected to the body 10 and a rear end portion positioned at rear (back) of an ear of the user.

The front end portion of the temple 20 is connected to the body.

The rear end portion of the temple 20 has a speaker accommodation part 225 in which the speaker 50 is accommodated.

Additionally, the temple 20 has a speaker hole 214 disposed in a front (at a front side) of the ear of the user. The speaker hole 214 is positioned to be apart from the speaker accommodation part 225 by a preset distance.

The speaker accommodation part 225 and the speaker hole 214 are connected in communication with each other.

The speaker 50 is seated in the speaker accommodation part 225.

The speaker 50 is a device that converts an electric acoustic signal into a sound wave, and indicates a generally used acoustic device. A detailed description of the speaker will be not be provided here.

The temple 20 includes a sound pressure conduit part 24 that causes the speaker accommodation part 225 to be connected in communication with the speaker hole 214, and a wire accommodation part 25 partitioned from the sound pressure conduit part 24.

The sound pressure conduit part 24 is a connection passage connecting the speaker accommodation part 225 to the speaker hole 214. In other words, the sound pressure conduit part 24 is a passage through which sound output from the speaker 50 is delivered.

Sound output from one surface of the speaker 50 moves along inside of the sound pressure conduit part 24 connected in communication with the speaker accommodation part 225, and then, output to outside through the speaker hole 214 connected in communication with the sound pressure conduit part 24.

The sound pressure conduit part 24 has a preset length and may be disposed to have a cross-section having a shape of a circular or a polygon. The shape of the cross-section may or may not be constant along a longitudinal direction of the sound pressure conduit part 24. That is, the shape of the cross-section may be changed along the longitudinal direction of the sound pressure conduit part 24.

Sound output from the speaker 50 inside the temple 20 is delivered to outside of the temple 20 through the speaker hole 214. In detail, the sound from the speaker 50 is delivered to the speaker hole 214 through the sound pressure conduit part 24, and delivered to outside of the temple 20 through the speaker hole 214.

Since the speaker hole 214 in the present disclosure is located in front of the ear of the user, the user may hear sound emitted from the speaker hole 214 more clearly compared to a head mounted display in the related art, etc., in which a speaker hole is located at a rear of an ear.

The wire accommodation part 25 accommodates various wires. In detail, the wire accommodation part 25 accommodates a battery wire 40W electrically connecting various electrical and electronic devices placed in the body 10 to a battery 60 and/or a speaker wire 50W electrically connecting various electrical and electronic devices to the speaker 50.

The wire accommodation part 25 has a preset length and may be disposed to have a cross-section having a shape of a circle or a polygon. The shape of the cross-section may or may not be constant along a longitudinal direction of the wire accommodation part 25. That is, the shape of the cross-section may be changed along the longitudinal direction of the wire accommodation part 25.

The sound pressure conduit part 24 and the wire accommodation part 25 are disposed inside the temple 20 and partitioned from each other. Here, being partitioned means that the sound pressure conduit part 24 and the wire accommodation part 25 are not connected to communicate with each other, but are independently distinguished from each other.

The temple 20 includes an inner temple 21 and an outer temple 22.

The temple 20 is constituted by combining the inner temple 21 and the outer temple 22. In detail, the temple 20 is constituted by combining the inner temple 21 and the outer temple 22 to face each other in a thickness direction.

The inner temple 21 is placed at a position facing the head of the user. That is, the inner temple 21 is placed at a position in contact with the head of the user or at a position adjacent to the head.

The inner temple 21 has a front end portion connected to the body 10 and a rear end portion positioned at the rear of the ear.

The outer temple 22 is positioned in an opposite direction to the head of the user. That is, the outer temple 22 is placed in an opposite direction (a direction facing outward) to the inner temple 21.

The outer temple 22 has a front end portion connected to the body 10 and a rear end portion positioned at the rear of the ear.

The sound pressure conduit part 24 and the wire accommodation part 25 each disposed in the temple 20 are constituted by combining the inner temple 21 with the outer temple 22, and are partitioned from each other.

The inner temple 21 includes an inner sound pressure conduit part 241 and an inner wire accommodation part 251, and the outer temple 22 has an outer sound pressure conduit part 242 and an outer wire accommodation part 252.

The inner sound pressure conduit part 241 disposed in the inner temple 21 corresponds to one portion of the sound pressure conduit 24 disposed in the temple 20, and the outer sound pressure conduit part 242 disposed in the outer temple 22 corresponds to a remaining portion of the sound pressure conduit part 24 disposed in the temple 20.

Therefore, when the inner temple 21 and the outer temple 22 are combined to be in surface contact with each other in a thickness direction, the inner sound pressure conduit part 241 of the inner temple 21, which is the one portion of the sound pressure conduit part 24, and the outer sound pressure conduit part 242 of the outer temple 22, which is the remaining portion of the sound pressure conduit part 24, are combined (coupled) with each other to constitute the sound pressure conduit part 24 of the temple. For example, the sound pressure conduit part 24 of a temple with a cross-section having a circular or polygonal shape is constituted. The sound pressure conduit part 24 of the temple 20 is disposed to be partitioned from the wire accommodation part 25 of the temple 20.

In addition, the inner wire accommodation part 251 disposed in the inner temple 21 corresponds to one portion of the wire accommodation part 25 disposed in the temple 20, and the outer wire accommodation part 252 disposed in the outer temple 22 corresponds to a remaining portion of the wire accommodation part 25 disposed in the temple 20.

Therefore, when the inner temple 21 and the outer temple 22 are combined to be in surface contact with each other in a thickness direction, the inner wire accommodation part 251 of the inner temple 21, which is the one portion of the wire accommodation part 25, and the outer wire accommodation part 252 of the outer temple 22, which is a remaining portion of the wire accommodation part 25, are combined with (coupled to) each other to constitute the wire accommodation part 25 of the temple. For example, the wire accommodation part 25 of the temple 20 with a cross-section having a circular or polygonal shape is constituted. The wire accommodation part 25 of the temple 20 is disposed to be partitioned from the sound pressure conduit part 24 of the temple 20.

Hereinafter, the temple 20, the sound pressure conduit part 24, and the wire accommodation part 25 are described in detail.

### First Embodiment of the Temple

FIGS. 6 to 10 and FIGS. 17 to 19 illustrate a first embodiment of a temple included in the face-mounted display device according to an embodiment of the present disclosure.

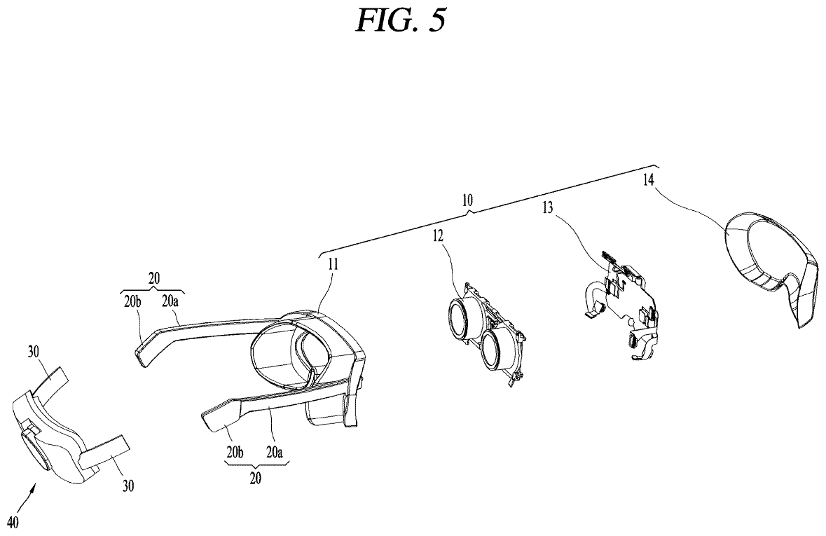

Referring back to FIGS. 5 to 10 and FIGS. 17 to 19, the temple 20 includes a first section 20a disposed by extending in one direction (a first direction) and a second section 20b disposed to extend from the first section 20a.

In other words, the temple 20 is constituted by the first section 20a extending in one direction (a first direction) and the second section 20b extending from the first section 20a in a direction (a second direction) other than the one direction (the first direction).

A width of the first section 20a is configured to be smaller than a width of the second section 20b. Here, the width of the first section 20a is a length of the first section 20a in a direction perpendicular to the first direction, and the width of the second section 20b is a length of the second section 20b in a direction perpendicular to the second direction. Since the width of the first section 20a is configured to be smaller than the width of the second section 20b, an effect of reducing a weight of the temple is obtained.

The first section 20a is located between the body 10 and the second section 20b.

The first section 20a is connected to the body.

A front end portion of the first section 20a corresponds to a front end portion of the temple 20 connected to the body 10, and a rear end portion of the second section 20b corresponds to a rear end portion of the temple 20 placed at a rear of an ear of the user.

The first section 20a is configured to have a preset length in one direction (the first direction). For example, the first section 20a is configured to have a rod shape with a preset length in one direction. Alternatively, the first section 20a is configured to have a linear shape with a preset length in one direction. The linear shape includes a straight line shape or a curved line shape close to a straight line.

The second section 20b extends from an end portion of the first section 20a. In detail, the second section 20b extends from an end portion of the first section 20a in a second direction intersecting with the first direction of the first section 20a.

An angle between a longitudinal central axial line of the first section 20a (a central axial line extending in the first direction) and a longitudinal central axial line of the second section 20b (a central axial line extending in the second direction) defines an acute angle.

An extension direction (the second direction) of the second section 20b is gradually inclined at a preset angle and is directed toward a lower portion of the head. In detail, the second section 20b is gradually inclined from a portion (a boundary region) connected to the first section 20a and extends in a direction toward a lower portion of the head of the user.

Accordingly, a rear end portion of the second section 20b wraps around an ear of the user. Thus, the face-mounted display device in the present disclosure is not easily separated from the head. In detail, when the temple 20 is to be separated in a forward direction, the rear end portion of the second section 20b gets caught on a rear surface of the ear, thus restricting the temple 20 from being separated in a forward direction.

As described above, the temple 20 includes the inner temple 21 and the outer temple 22. Accordingly, the inner temple 21 and the outer temple 22 are configured as the first sections 21a and 22a and the second section 21b and 22b, respectively.

The inner temple 21 includes a base 211 having a plate shape including the first section 21a and the second section 21b, and a side wall 212 protruding in a thickness direction along an edge of the base 211.

In other words, the side wall 212 extends from the edge of the base 211 in a direction perpendicular to the base 211 and is disposed along the edge of the base 211. Accordingly, the inner temple 21 has an inner space surrounded by the side wall 212 and including one open side.

In addition, the inner temple 21 has an inner partition wall 213 protruding from an inner surface of the base 211 and configured to have a preset length. The inner partition wall 213 has one or more bent shapes.

The inner partition wall 213 is disposed to extend or protrude in a direction perpendicular to the inner surface of the base 211 (or in a thickness direction of the temple).

A height of the inner partition wall 213 may be identical to or different from a height of the side wall 212.

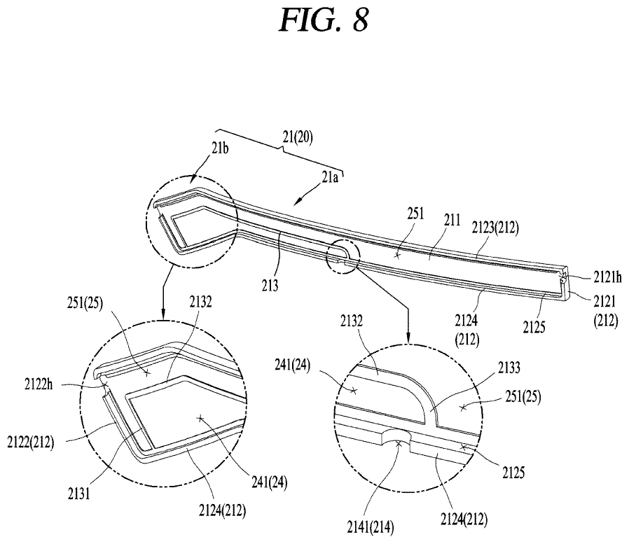

The inner partition wall 213 includes a first inner partition wall 2131 to a third inner partition wall 2133 combined (connected) as one (see FIG. 8).

The first inner partition wall 2131 extends from a lower wall 2124 of the inner temple 21 (the second section 21b) spaced apart from a side wall 2122 of a rear end portion of the inner temple 21 (in detail, the second section 21b) by a preset distance in a same direction as that of the side wall 2122 of the rear end portion of the inner temple 21 (the second section 21b).

The second inner partition wall 2132 is disposed at a position spaced apart from an upper wall 2123 of the inner temple 21 (the first section 21a and the second section 21b) by a preset distance in a same direction as that of the upper wall 2123 of the inner temple 21 (the first section 21a and the second section 21b), and configured to have a preset length toward a front end portion of the inner temple 21 (the first section 21a).

The third inner partition wall 2133 is connected to the lower wall 2124 of the inner temple 21 (the first section 21a).

A boundary region in which the first inner partition wall 2131 is connected to the second inner partition wall 2132, and a boundary region in which the second inner partition wall 2132 is connected to the third inner partition wall 2133 are bent.

Additionally, each of the first inner partition wall 2131 to the third inner partition wall 2133 may include one or more bent shapes to correspond to a shape of the temple 20.

The inner sound pressure conduit part 241 is a type of a space (an inner space) surrounded by the inner partition wall 213 described above (the first inner partition wall 2131 to the third inner partition wall 2133) and the lower wall 2124 of the inner temple 21 (the first section 21a and the second section 21b). Sound output from a speaker is delivered to outside of the temple 20 through the inner sound pressure conduit part 241 and the speaker hole 214.

In addition, although not shown, according to another embodiment of the present disclosure, the inner partition wall 213 is configured to have a preset length from the side wall 2122 in a rear end portion of the inner temple 21 (the second section 21b) in a direction toward a front end portion of the inner temple 21 (the first section 21a), and connected to the lower wall 2124 of the inner temple 21 (the first section 21a). The inner partition wall 213 is disposed to be spaced apart from the upper wall 2123 of the inner temple 21 (the first section 21a and the second section 21b) by a preset distance. In addition, the inner partition wall 213 may have one or more bent shapes. In this embodiment, the inner sound pressure conduit part 241 is a type of a space (an inner space) surrounded by the side wall 2122 in a rear end portion of the inner temple 21 (the second section 21b), the inner partition wall 213 described above, and the lower wall 2124 of the inner temple 21 (the first section 21a and the second section 21b). Sound output from a speaker is delivered to outside of the temple 20 through the inner sound pressure conduit part 241 and the speaker hole 214.

The inner temple 21 has a speaker hole 2141 connected in communication with the inner sound pressure conduit part 241.

The speaker hole 2141 is disposed on the lower wall 2124 of the inner temple 21 (the first section 21a). The speaker hole 2141 is disposed in the temple 20 to be at a position in front of the ear.

In detail, when the user wears the face-mounted display device on the head, the speaker hole 2141 is located in front of the ear and disposed on the lower wall 2124 of the inner temple 21 (the first section 21a) adjacent to the ear. Accordingly, the user may clearly hear the sound delivered through the speaker hole 2141 located in front of the ear.

The speaker hole 2141 may be configured as a through hole in the lower wall 2124 of the inner temple 21 (the first section 21a).

Alternatively, the speaker hole 2141 may be configured as a groove recessed on an upper surface of the lower wall 2124 of the inner temple 21 (the first section 21a). The groove may be surrounded by an upper surface of the lower wall 2224 of the outer temple 22 (the first section 22a), which will be described later, to become a through hole (in this embodiment, a groove is not present on the upper surface of the lower wall 2224 of the outer temple 22). Alternatively, the groove may be connected (combined) with a groove recessed on an upper surface disposed on the lower wall 2224 of the outer temple 22 (the first section 22a) to become a through hole (e.g., a circular, oval, or polygonal through hole).

The inner sound pressure conduit part 241 is partitioned from the inner wire accommodation part 251 to be described later by the inner partition wall 213, within the inner temple 21 surrounded by the side wall 212 of the inner temple 21.

The inner wire accommodation part 251 corresponds to a region in the inner temple 21, other than the inner sound pressure conduit part 241.

In detail, the inner wire accommodation part 251 is a type of a space (an inner space) surrounded by the inner partition wall 213, the lower wall 2124 of the inner temple 21 (the first section 21a), a side wall 2121 of a front end portion of the inner temple 21 (the first section 21a), the upper wall 2123 of the inner temple 21 (the first section 21a and the second section 21b), the side wall 2122 in a rear end portion of the inner temple 21 (the second section 21b), and the lower wall 2124 of the inner temple 21 (the second section 21b). Here, the lower wall 2124 of the inner temple 21 indicates a portion of the lower wall 2124 of the inner temple 21, other than the lower wall 2124 of the inner temple 21 constituting the inner sound pressure conduit part 241.

In addition, in another embodiment of the present disclosure that is described above but is not illustrated, the inner wire accommodation part 251 is a type of a space (an inner space) surrounded by the side wall 2122 in a rear end portion of the inner temple 21 (the second section 21b), the inner partition wall 213, the lower wall 2124 of the inner temple 21 (the first section 21a), the side wall 2121 in a front end portion of the inner temple 21 (the first section 21a), and the upper wall 2123 of the inner temple 21 (the first section 21a and the second section 21b). Here, the side wall 2122 in the rear end portion of the inner temple 21 (the second section 21b) indicates a portion of the side wall 2122 in a rear end portion of the inner temple 21 (the second section 21b), other than the side wall 2122 in a rear end portion of the inner temple 21 (the second section 21b) defining the inner sound pressure conduit part 241. In addition, the lower wall 2124 of the inner temple 21 (the first section 21a) indicates a portion of the lower wall 2124 of the inner temple 21 (the first section 21a), other than the lower wall 2124 of the inner temple 21 (the first section 21a) defining the inner sound pressure conduit part 241.

Accordingly, the inner wire accommodation part 251 is partitioned from the inner sound pressure conduit part 241 described above by the inner partition wall 213, within the inner temple 21 surrounded by the side wall 212 of the inner temple 21.

The inner wire accommodation part 251 accommodates a speaker wire 50W connected to the speaker 50.

Additionally, in an embodiment in which the battery 60 is placed on a rear surface of a head of a user, the inner wire accommodation part 251 accommodates the battery wire 40W connecting the battery 60 to an electrical and electronic device placed on the body 10.

The inner temple 21 has a side wall hole connected to communicate with the inner wire accommodation part 251.

The side wall hole is disposed in the side wall 2121 in a front end portion of the inner temple 21 (the first section 21a). The side wall hole disposed in the side wall 2121 in the front end portion of the inner temple 21 (the first section 21a) is referred to as a ‘front side wall hole 2121h.’

The front side wall hole 2121h is a passage through which the speaker wire 50W and/or the battery wire 40W each accommodated in the inner wire accommodation part 251 pass. The speaker wire 50W and/or the battery wire 40W pass through the front side wall hole 2121h, and then, are connected to an electric and electronic device placed in the body 10.

The front side wall hole 2121h may be configured as a through hole in the side wall 2121 in a front end portion of the inner temple 21 (the first section 21a).

Alternatively, the front side wall hole 2121h may be disposed as a groove recessed on an upper surface of the side wall 2121 in a front end portion of the inner temple 21 (the first section 21a). The groove may be surrounded by an upper surface of the side wall 2221 in a front end portion of the outer temple 22 (the first section 22a), which will be described later, to become a through hole (in this embodiment, a groove is not present on the upper surface of the side wall 2221 in the front end portion of the outer temple 22).

Alternatively, the groove may be connected (combined) with the front side wall hole 2221h of the outer temple 22 (the first section 22a) to be described later to become a through hole. In detail, the groove may be connected (combined) with the groove 2221h recessed an upper surface disposed on the side wall 2221 in a front end portion of the outer temple 22 (the first section 22a) to become a through hole (for example, a circular, oval, or polygonal through hole).

Additionally, in an embodiment in which the battery 60 is placed on a rear surface of a head of a user, a side wall hole is also disposed in the side wall 2122 in a rear end portion of the inner temple 21 (the second section 21b). The side wall hole disposed in the side wall 2122 in a rear end portion of the inner temple 21 (the second section 21b) is referred to as a ‘rear side wall hole 2122h.’

The rear side wall hole 2122h is a passage through which the battery wire 40W and/or other wires each accommodated in the inner wire accommodation part 251 pass. The battery wire 40W and/or the other wires pass through the rear side wall hole 2122h, and then, are connected to the battery 60 located on a rear surface of the head.

The rear side wall hole 2122h may be configured as a through hole in the side wall 2122 in a rear end portion of the inner temple 21 (the second section 21b).

Alternatively, the rear side wall hole 2122h may be disposed as a groove recessed on an upper surface of the side wall 2122 in a rear end portion of the inner temple 21 (the second section 21b). The groove may be surrounded by an upper surface of the side wall 2222 in a rear end portion of the outer temple 22 (the second section 22b), which will be described later, to become a through hole (in this embodiment, a groove is not present on the upper surface of the side wall 2222 in the rear end portion of the outer temple 22).

Alternatively, the groove may be connected (combined) with a rear side wall hole 2222h of the outer temple 22 (the second section 22b) to become a through hole. In detail, the groove may be connected (combined) with the groove 2222h recessed on an upper surface disposed on the side wall 2222 in a rear end portion of the outer temple 22 (the second section 22b) to become a through hole (for example, a circular, oval, or polygonal through hole).

Meanwhile, the outer temple 22 includes the outer sound pressure conduit part 242 and the outer wire accommodation part 252 disposed to correspond to the inner sound pressure conduit part 241 and the inner wire accommodation part 251 of the inner temple 21 each described above, respectively.

In detail, the outer temple 22 includes the outer sound pressure conduit part 242 and the outer wire accommodation part 252 disposed in positions and/or shapes corresponding to the inner sound pressure conduit part 241 and the inner wire accommodation part 251 of the inner temple 21, respectively.

The outer temple 22 includes a base 221 having a plate shape configured as the first section 22a and the second section 22b, and the side wall 222 protruding in a thickness direction along an edge of the base 221.

The base 221 and the side wall 222 of the outer temple 22 are disposed to correspond to the base 211 and the side wall 212 of the inner temple 21 described above, respectively.

In detail, the base 221 and the side wall 222 of the outer temple 22 are disposed in positions and/or shapes corresponding to the base 211 and the side wall 212 of the inner temple 21 described above, respectively.

The side wall 222 of the outer temple 22 extends from an edge of the base 221 in a direction perpendicular to the base 221 and is disposed along the edge of the base 221.

Accordingly, the outer temple 22 is surrounded by the side wall 222 and has an inner space with one open side.

When the outer temple 22 and the inner temple 21 are in surface contact to be combined with each other in a thickness direction, the side wall 222 of the outer temple 22 comes into surface contact with the side wall 212 of the inner temple 21. In detail, an upper surface of the side wall 222 of the outer temple 22 and an upper surface of the side wall 212 of the inner temple 21 are in surface contact with each other.

Accordingly, due to the combination of the outer temple 22 and the inner temple 21, the temple has a closed inner space surrounded by the base 221 and the side wall 222 of the outer temple 22 and the base 211 and the side wall 212 of the inner temple 21.

The outer temple 22 and the inner temple 21 may be engaged with each other, for example, by a forced-fit method.

The outer temple 22 has a coupling protruding part 2225, and the inner temple 21 has a coupling groove 2125 engaged with the coupling protruding part 2225. Due to coupling between the coupling protruding part 2225 and the coupling groove 2125, the outer temple 22 and the inner temple 21 are combined to be in surface contact with each other in a thickness direction.

In detail, on the side wall 222 of the outer temple 22, the coupling protruding part 2225 protruding in a direction toward the inner temple 21 may be disposed along the side wall 222.

The coupling protruding part 2225 may be disposed as one continuous part seamlessly along the side wall 222, or may be disposed in plurality at regular intervals along the side wall 222.

In addition, the coupling groove 2125 into which the coupling protruding part 2225 of the outer temple 22 is forced-fit may be disposed on the side wall 212 of the inner temple 21 as one continuous part seamlessly or in plurality at regular intervals. The coupling protruding part 2225 and the coupling groove 2125 are disposed at positions corresponding to each other.

The coupling protruding part 2225 of the outer temple 22 is forced-fit into the coupling groove 2125 of the inner temple 21. At this time, an upper surface of the side wall 222 of the outer temple 22 and an upper surface of the side wall 212 of the inner temple 21 are in surface contact with each other. Due to the forced fitting, the outer temple 22 and the inner temple 21 are not easily separated from each other.

Alternatively, unlike the embodiment described above, the coupling protruding part 2225 of the outer temple 22 may be disposed on the inner temple 21, and the coupling groove 2125 of the inner temple 21 may be disposed on the outer temple 22 to cause the outer temple 22 and the inner temple 21 to be in surface contact to be combined with each other in a thickness direction.

The outer temple 22 and the inner temple 21 may be combined with each other using various engagement methods such as a hook coupling method, other than the forced-fit method described above.

Meanwhile, the outer temple 22 has an inner partition wall 223 protruding from an inner surface of the base 221 and configured to have a preset length. The inner partition wall 223 has one or more bent shapes.

The inner partition wall 223 of the outer temple 22 is disposed to correspond to the inner partition wall 213 of the inner temple 21 described above.

In detail, the inner partition wall 223 of the outer temple 22 is disposed in a position and/or a shape, respectively, corresponding to the inner partition wall 213 of the inner temple 21 described above.

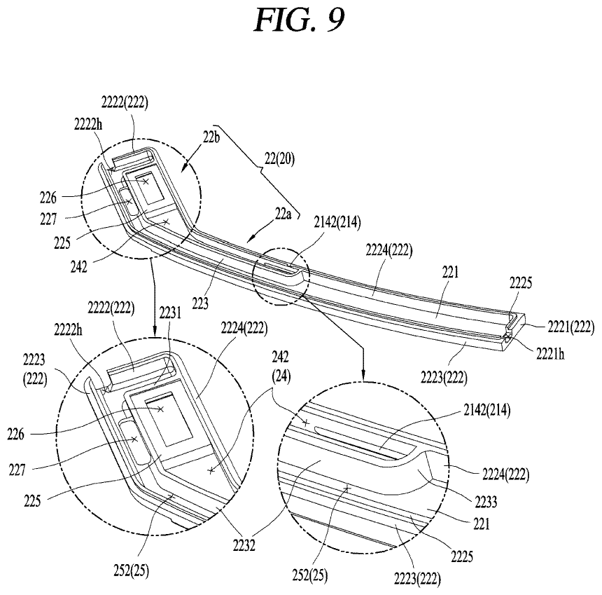

The inner partition wall 223 of the outer temple 22 includes a first inner partition wall 2231 to a third inner partition wall 2233 combined (connected) as one (see FIG. 9).

The first inner partition wall 2231 extends from the lower wall 2124 of the outer temple 22 (the second section 22b) spaced apart from the side wall 2222 in a rear end portion of the outer temple 22 (in detail, the second section 22b) by a preset distance in a same direction as the side wall 2222 in a rear end portion of the outer temple 22 (the second section 22b).

The second inner partition wall 2232 is disposed at a position spaced apart from an upper wall 2223 of the outer temple 22 (the first section 22a and the second section 22b) by a preset distance in a same direction as that of the upper wall 2223 of the outer temple 22 (the first section 22a and the second section 22b), and configured to have a preset length toward a front end portion of the outer temple 22 (the first section 22a).

The third inner partition wall 2233 is connected to the lower wall 2224 of the outer temple 22 (the first section 22a).

In the outer temple 22, a boundary region in which the first inner partition wall 2231 is connected to the second inner partition wall 2232, and a boundary region in which the second inner partition wall 2232 is connected to the third inner partition wall 2233 are bent.

Additionally, in the outer temple 22, each of the first inner partition wall 2231 to the third inner partition wall 2233 may include one or more bent shapes to correspond to a shape of the temple 20.

The outer sound pressure conduit part 242 is a type of space (an inner space) surrounded by the inner partition wall 223 described above (the first inner partition wall 2231 to the third inner partition wall 2233) and the lower wall 2224 of the outer temple 22 (the first section 22a and the second section 22b). Sound output from the speaker 50 is delivered to outside of the temple 20 through the outer sound pressure conduit part 242 and the speaker hole 214 to be described later.

In addition, although not shown, according to another embodiment of the present disclosure, the inner partition wall 223 of the outer temple 22 is configured to have a preset length from the side wall 2222 in a rear end portion of the outer temple 22 (the second section 22b) in a direction toward a front end portion of the outer temple 22 (the first section 22a), and connected to the lower wall 2224 of the outer temple 22 (the first section 22a). The inner partition wall 223 is disposed to be spaced apart from the upper wall 2223 of the outer temple 22 (the first section 22a and the second section 22b) by a preset distance. In addition, the inner partition wall 223 may have one or more bent shapes. In this embodiment, the outer sound pressure conduit part 242 is a type of a space (an inner space) surrounded by the side wall 2222 in a rear end portion of the outer temple 22 (the second section 22b), the inner partition wall 223, and the lower wall 2224 of the outer temple 22 (the first section 22a and the second section 22b). Sound output from a speaker is delivered to outside of the temple 20 through the outer sound pressure conduit part 242 and the speaker hole 214.

The inner partition wall 223 of the outer temple 22 is disposed to extend or protrude in a direction perpendicular to an inner surface of the base 221 (or in a thickness direction of the temple). A height of the inner partition wall 223 may be identical to or different from a height of the side wall 222 of the outer temple 22.

When the outer temple 22 and the inner temple 21 are in surface contact to be combined with each other in a thickness direction, the inner partition wall 223 of the outer temple 22 comes into surface contact with the inner partition wall 213 of the inner temple 21. A height of the inner partition wall 223 of the outer temple 22 may be identical to or different from a height of the inner partition wall 213 of the inner temple 21. For example, when a height of the inner partition wall 223 of the outer temple 22 is configured to be great, a height of the inner partition wall 213 of the inner temple 21 is configured to be relatively small. In addition, when a height of the inner partition wall 223 of the outer temple 22 is configured to be small, a height of the inner partition wall 213 of the inner temple 21 is configured to be relatively great. Thus, the sound pressure conduit part 24 and the wire accommodation part 25 of the temple 20 are partitioned from each other to have the inner partition walls 213 and 223 therebetween.

The outer temple 22 has a speaker hole 2142 connected in communication with the outer sound pressure conduit part 242.

The speaker hole 2142 of the outer temple 22 is disposed on the lower wall 2224 of the outer temple 22 (the first section 22a). In addition, the speaker hole 214 is disposed in the temple 20 to be in front of an ear.

In detail, when a user wears the face-mounted display device on a head, the speaker hole 2142 is located in front of an ear and disposed on the lower wall 2224 of the outer temple 22 (the first section 22a) adjacent to the ear. Accordingly, the user may clearly hear sound delivered through the speaker hole 2142 located in front of the ear.

The speaker hole 2142 of the outer temple 22 may be configured as a through hole in the lower wall 2224 of the outer temple 22 (the first section 22a).

Alternatively, the speaker hole 2142 of the outer temple 22 (the first section 22a) may be configured as a groove recessed on an upper surface of the lower wall 2224 of the outer temple 22 (the first section 22a). The groove may be surrounded by an upper surface of the lower wall 2124 of the inner temple 21 (the first section 21a) described above to become a through hole (in this embodiment, a groove is not present on the upper surface of the lower wall 2124 of the inner temple 21). Alternatively, the groove may be connected (combined) with a groove recessed on an upper surface disposed on the lower wall 2124 of the inner temple 21 (the first section 21a) to become a through hole.

The outer sound pressure conduit part 242 is partitioned from the outer wire accommodation part 252 to be described later by the inner partition wall 223, inside the outer temple 22 surrounded by the side wall 222 of the outer temple 22.

The outer wire accommodation part 252 corresponds to a region in the outer temple 22, other than the outer sound pressure conduit part 242.

In detail, the outer wire accommodation part 252 is a kind of a space (an inner space) surrounded by the inner partition wall 223, the lower wall 2224 of the outer temple 22 (the first section 22a), the side wall 2221 in a front end portion of the outer temple 22 (the first section 22a), the upper wall 2223 of the outer temple 22 (the first section 22a and the second section 22b), the side wall 2222 in a rear end portion of the outer temple 22 (the second section 22b), and the lower wall 2224 of the outer temple 22 (the second section 22b). Here, the lower wall 2224 of the outer temple 22 indicates a portion of the lower wall 2224 of the outer temple 22, other than the lower wall 2224 of the outer temple 22 defining the outer sound pressure conduit part 242.

In addition, in another embodiment of the present disclosure that is described above but is not illustrated, the outer wire accommodation part 252 is a type of a space (an inner space) surrounded by the side wall 2222 in a rear end portion of the outer temple 22 (the second section 22b), the inner partition wall 223, the lower wall 2224 of the outer temple 22 (the first section 22a), the side wall 2221 in a front end portion of the outer temple 22 (the first section 22a), and the upper wall 2223 of the outer temple 22 (the first section 22a and the second section 22b). Here, the side wall 2222 in the rear end portion of the outer temple 22 (the second section 22b) indicates a portion of the side wall 2222 in the rear end portion of the outer temple 22 (the second section 22b), other than the side wall 2222 in a rear end portion of the outer temple 22 (the second section 22b) defining the outer sound pressure conduit part 242. In addition, the lower wall 2224 of the outer temple 22 (the first section 22a) indicates a portion of the lower wall 2224 of the outer temple 22 (the first section 22a), other than the lower wall 2224 of the outer temple 22 (the first section 22a) defining the outer sound pressure conduit part 242.

Accordingly, the outer wire accommodation part 252 is partitioned from the outer sound pressure conduit part 242 described above by the inner partition wall 213, inside the outer temple 22 surrounded by the side wall 222 of the outer temple 22.

The outer wire accommodation part 252 accommodates the speaker wire 50W connected to the speaker 50.

Additionally, in an embodiment in which the battery 60 is placed on a rear surface of a head of a user, the outer wire accommodation part 252 accommodates the battery wire 40W connecting the battery 60 to an electrical and electronic device placed on the body 10.

The outer temple 22 has a side wall hole connected in communication with the outer wire accommodation part 252.

The side wall hole of the outer temple 22 is disposed in the side wall 2221 in a front end portion of the outer temple 22 (the first section 22a). The side wall hole disposed in the side wall 2221 in the front end portion of the outer temple 22 (the first section 22a) is referred to as a ‘front side wall hole 2221h.’

The front side wall hole 2221h of the outer temple 22 (the first section 22a) is a passage through which the speaker wire 50W and/or the battery wire 40W each accommodated in the outer wire accommodation part 252 pass. The speaker wire 50W and/or the battery wire 40W pass through the front side wall hole 2221h of the outer temple 22 (the first section 22a), and then, are connected to an electric and electronic device placed in the body 10.

The front side wall hole 2221h of the outer temple 22 (the first section 22a) may be configured as a through hole in the side wall 2221 in a front end portion of the outer temple 22 (the first section 22a).

Alternatively, the front side hole 2221h of the outer temple 22 (the first section 22a) may be configured as a groove recessed on an upper surface of the side wall 2221 in a front end portion of the outer temple 22 (the first section 22a). The groove may be surrounded by an upper surface of the side wall 2121 in a front end portion of the inner temple 21 (the first section 21a) described above to become a through hole (in this embodiment, a groove is not present on the upper surface of the side wall 2121 in the front end portion of the inner temple 21).

Alternatively, the groove may be connected (combined) with the front side wall hole 2121h of the inner temple 21 (the first section 21a) to become a through hole. In detail, the groove may be connected (combined) with the groove 2121h recessed on an upper surface disposed on the side wall 2121 in a front end portion of the inner temple 21 to become a through hole (for example, a circular, oval, or polygonal through hole).

Additionally, in an embodiment in which the battery 60 is placed on a rear surface of a head of a user, a side wall hole of the outer temple 22 is also disposed in the side wall 2222 in a rear end portion of the outer temple 22 (the second section 22b). The side wall hole disposed in the side wall 2222 in a rear end portion of the outer temple 22 (the second section 22b) is referred to as a ‘rear side wall hole 2222h.’

The rear side wall hole 2222h of the outer temple 22 (the second section 22b) is a passage through which the battery wire 40W and/or other wires each accommodated in the outer wire accommodation part 252 pass. The battery wire 40W and/or the other wires pass through the rear side wall hole 2222h of the outer temple 22 (the second section 22b), and then, are connected to the battery 60 located on a rear surface of the head.

The rear side wall hole 2222h of the outer temple 22 (the second section 22b) may be configured as a through hole in the side wall 2222 in a rear end portion of the outer temple 22 (the second section 22b).

Alternatively, the rear side hole 2222h of the outer temple 22 (the second section 22b) may be configured as a groove recessed on an upper surface of the lower wall 2222 in a rear end portion of the outer temple 22 (the second section 22b). The groove may be surrounded by an upper surface of the side wall 2122 in a rear end portion of the inner temple 21 (the second section 21b) described above to become a through hole (in this embodiment, a groove is not present on the upper surface of the side wall 2122 in the rear end portion of the inner temple 21).

Alternatively, the groove may be connected (combined) with the rear side wall hole 2122h of the inner temple 21 (the second section 21b) to become a through hole. In detail, the groove may be connected (combined) with the groove 2122h recessed on an upper surface disposed on the side wall 2122 in a rear end portion of the inner temple 21 (the second section 21b) to become a through hole (for example, a circular, oval, or polygonal through hole).

In addition, the outer temple 22 (the second section 22b) includes a speaker accommodation part 225 disposed on an outer surface, a speaker accommodation part hole 226 disposed through the speaker accommodation part 225, and a back volume hole 227 disposed through a position spaced apart from the speaker accommodation part 225 by a preset distance.

The outer sound pressure conduit part 242 and the outer wire accommodation part 252 each described above and located on the outer temple 22 are disposed on an inner surface (an inner side) of the outer temple 22, and the speaker accommodation part 225 and the speaker accommodation part hole 226 are disposed on an outer surface (an outer side) of the outer temple 22.

The speaker accommodation part 225 accommodates the speaker 50.

The speaker accommodation part 225 is disposed at a position adjacent to a rear end portion of the outer temple 22 (the second section 22b). Accordingly, the speaker accommodation part 225 and the speaker 50 are placed at a rear of an ear of the user.

In addition, the speaker accommodation part 225 is disposed in the outer sound pressure conduit part 242 disposed on an inner surface (an inner side) of the outer temple 22. In other words, the speaker accommodation part 225 is disposed on an outer surface (an outer side) of the outer temple 22 (the second section 22b), and disposed on the outer sound pressure conduit part 242 when viewed from an inner surface of the outer temple 22 (the second section 22b).

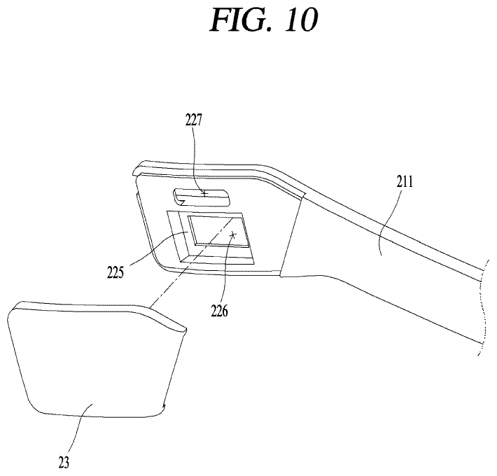

However, the speaker accommodation part 225 is not limited to a particular shape. The speaker accommodation part 225 may be configured in various shapes in which the speaker 50 may be seated. For example, as illustrated in FIG. 10, the speaker accommodation part 225 may be configured as a groove configured in a preset depth and having the speaker 50 accommodated therein.

The speaker accommodation part 225 is connected in communication with the outer sound pressure conduit part 242 by the speaker accommodation part hole 226.

The speaker accommodation part hole 226 is disposed in the speaker accommodation Part 225.

The speaker accommodation part hole 226 is a through hole penetrating through the outer temple 22 (the second section 22b) and connected in communication with the outer sound pressure conduit part 242.

In the outer sound pressure conduit part 242, the speaker accommodation part hole 226 is located at a rear of the ear of the user, and the speaker hole 214 is located in front of the ear of the user.

The speaker accommodation part hole 226, the sound pressure conduit part 24, and the speaker hole 214 are connected in communication with each other. Here, the sound pressure conduit part 24 is a passage when the inner sound pressure conduit part 241 is combined with the outer sound pressure conduit part 242. In addition, the speaker hole 214 refers to speaker holes 214 disposed in the inner sound pressure conduit part 241 and/or the outer sound pressure conduit part 242, respectively, or refers to a speaker hole 214 constituted by combining speaker holes 214 disposed in the inner sound pressure conduit part 241 and the outer sound pressure conduit part 242, respectively.

When the speaker 50 is accommodated in the speaker accommodation part 225, a front surface of the speaker 50 from which sound is emitted is directed toward the speaker accommodation part hole 226. Accordingly, the sound emitted from the speaker 50 is delivered to outside of the temple 20 through the speaker accommodation part hole 226, the sound pressure conduit part 24, and the speaker hole 214. At this time, the user may clearly hear the sound delivered through the speaker hole 214 located in front of the ear.

The back volume hole 227 is disposed to be apart from the speaker accommodation part 225 by a preset distance.

A speaker needs a space in which sound generated from the speaker can vibrate.

The speaker generates sound (a sound wave) due to vibration of a diaphragm included therein. An air flow is needed for the diaphragm to move (vibrate) smoothly. In other words, volume of a space (back volume) in which the sound generated from the speaker may vibrate is needed so that the diaphragm moves smoothly.

A micro speaker generally used in wearable devices also needs back volume to produce good sound quality. However, since it is structurally difficult to secure sufficient back volume for small wearable devices, there is a need to improve (change) a structure to increase the back volume.

When the back volume is completely blocked as ventilation is not performed, a temperature of inner air rises due to heat generated from a voice coil included a speaker (e.g., a micro speaker), and thus, pressure within the back volume is increased.

In addition, when the back volume has too much ventilation (low sealing), amplitude characteristics deteriorates.

Accordingly, it is important to have a back volume structure that may increase a sealing degree while preventing an increase in pressure within the back volume.

The back volume hole 227 in the present disclosure functions to expand back volume of the face-mounted display device. That is, the back volume of the face-mounted display device is expanded through the back volume hole 227.

The back volume hole 227 is a through hole penetrating through the outer temple 22 (the second section 22b) and connected in communication with the outer wire accommodation part 252. Accordingly, the outer wire accommodation part 252 performs a function of back volume. Additionally, the back volume hole 227 may function as a passage through which the speaker wire 50W connected to the speaker 50 passes.

The wire accommodation part 25 of the temple 20 (an inner space of the temple) constituted by combining the outer wire accommodation part 252 of the outer temple 22 and the inner wire accommodation part 251 of the inner temple 21 performs a function of back volume. Accordingly, an effect of expanding the back volume through the back volume hole 227 is obtained.

The back volume hole 227 is disposed at a location adjacent to the speaker accommodation part 225 of the outer temple 22 (the second section 22b).

The back volume hole 227 is disposed through the outer wire accommodation part 252 disposed on an inner surface of the outer temple 22. Accordingly, volume of a rear space in the speaker 50 placed in the speaker accommodation part 225 is expanded to the wire accommodation part 25 through the back volume hole 227.

A shape of the back volume hole 227 is not limited to a particular shape, and may be configured in a circular, oval, or polygonal shape, etc.

The face-mounted display device according to one embodiment of the present disclosure includes a speaker cover 23.

The speaker cover 23 is engaged with outside of the outer temple 22 (the second section 22b) to cover the speaker 50.

In detail, the speaker cover 23 covers the speaker accommodation part 225 and the back volume hole 227.

The speaker cover 23 may be engaged with the outer temple 22 (the second section 22b) using a forced-fit method.

In detail, at an edge of the speaker cover 23, a protruding part protruding toward the speaker accommodation part 225 may be disposed along the edge.

In addition, on an outer surface (an outer side) of the outer temple 22, a groove into which the protruding part of the speaker cover 23 is forced-fit is disposed at an edge to which the speaker cover 23 is coupled. Here, a portion of the edge to which the speaker cover 23 is coupled indicates an edge of the outer temple 22 (the second section 22b) at which the speaker accommodation part 225 and the back volume hole 227 are disposed.

The protruding part of the speaker cover 23 is forced-fit into the groove of the outer temple 22. At this time, an inner surface of the protruding part of the speaker cover 23 and a side surface of the groove of the outer temple 22 come into contact with each other by the forced-fitting. Due to the forced-fitting, the speaker cover 23 is not easily separated from the outer temple 22.

A shape of the speaker cover 23 is not limited to a particular shape. When the speaker cover 23 is capable of covering the speaker accommodation part 225 and the back volume hole 227, the speaker cover 23 may be configured in various shapes.

### Second Embodiment of the Temple

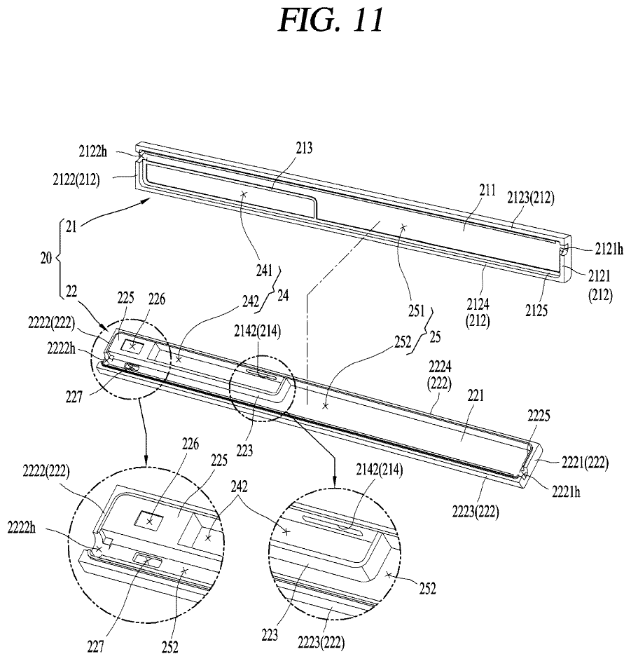

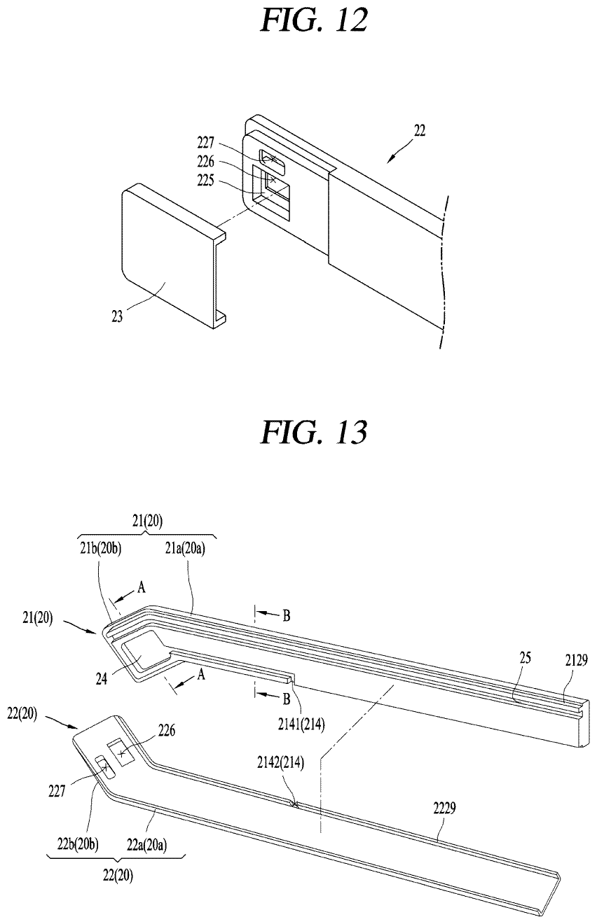

FIGS. 11 to 12 illustrate a second embodiment of a temple included in a face-mounted display device according to another embodiment of the present disclosure.

Referring to FIGS. 11 and 12, according to another embodiment of the present disclosure, the temple is disposed to extend in one direction (a first direction). In other words, the temple is disposed to extend in one direction (the first direction).

In another embodiment of the present disclosure, the inner temple 21 includes the base 211 with a plate shape having a preset length in the one direction (the first direction) and the side wall 212 protruding in a thickness direction along an edge of the base 211.

In other words, the side wall 212 extends from the edge of the base 211 in a direction perpendicular to the base 211 to be disposed along the edge of the base 211.

Accordingly, the inner temple 21 has an inner space surrounded by the side wall 212 and having one open side.

In addition, the inner temple 21 has the inner partition wall 213 protruding from an inner surface of the base 211 and configured to have a preset length.

In detail, the inner partition wall 213 is configured to have a preset length from the side wall 2122 in a rear end portion of the inner temple 21 in a direction toward a front end portion of the inner temple 21, and connected to the lower wall 2124 of the inner temple 21. The inner partition wall 213 may have one or more bent shapes.

The inner partition wall 213 is disposed to extend or protrude in a direction perpendicular to an inner surface of the base 211 (or in a thickness direction of the temple 20).

A height of the inner partition wall 213 may be identical to or different from a height of the side wall 212.

The inner sound pressure conduit part 241 is a type of a space (an inner space) surrounded by the side wall 2122 in a rear end portion of the inner temple 21, the inner partition wall 213 described above, and the lower wall 2124. Sound (a sound wave) output from a speaker is delivered to outside of the temple 20 through the inner sound pressure conduit part 241 and the speaker hole 214 to be described later.

The inner temple 21 includes the speaker hole 214 connected in communication with the inner sound pressure conduit part 241.

The speaker hole 214 is disposed on the lower wall 2124 of the inner temple 21. The speaker hole 214 is disposed in the temple 20 to be in front of an ear.

In detail, when a user wears the face-mounted display device on a head, the speaker hole 214 is disposed in front of an ear, and arranged on the lower wall 2124 of the inner temple 21 adjacent to the ear. Accordingly, the user may clearly hear sound delivered through the speaker hole 214 located in front of the ear.

The speaker hole 214 may be configured as a through hole in the lower wall 2124 of the inner temple 21.

Alternatively, the speaker hole 214 may be configured as a groove recessed on an upper surface of the lower wall 2124 of the inner temple 21. The groove may be surrounded by an upper surface of the lower wall 2224 of the outer temple 22 which will be described later to become a through hole (in this embodiment, a groove is not present on the upper surface of the lower wall 2224 of the outer temple 22). Alternatively, the groove may be connected (combined) with a groove recessed on an upper surface disposed on the lower wall 2224 of the outer temple 22 to become a through hole (e.g., a circular, oval, or polygonal through hole).

The inner sound pressure conduit part 241 is partitioned from the inner wire accommodation part 251 to be described later by the inner partition wall 213, within the inner temple 21 surrounded by the side wall 212 of the inner temple 21.

The inner wire accommodation part 251 corresponds to a region in the inner temple 21, other than the inner sound pressure conduit part 241.

In detail, the inner wire accommodation part 251 is a type of a space (an inner space) surrounded by the side wall 2122 in a rear end portion of the inner temple 21, the inner partition wall 213, the lower wall 2124, the side wall 2121 in a front end portion, and the upper wall 2123. Here, the side wall 2122 in the rear end portion of the inner temple 21 indicates a portion of the side wall 2122 in a rear end portion of the inner temple 21, other than the side wall 2122 in a rear end portion of the inner temple 21 defining the inner sound pressure conduit part 241. In addition, the lower wall 2124 of the inner temple 21 indicates a portion of the lower wall 2124 of the inner temple 21, other than the lower wall 2124 of the inner temple 21 constituting the inner sound pressure conduit part 241.

Accordingly, the inner wire accommodation part 251 is partitioned from the inner sound pressure conduit part 241 described above by the inner partition wall 213, within the inner temple 21 surrounded by the side wall 212 of the inner temple 21.

The inner wire accommodation part 251 accommodates the speaker wire 50W connected to the speaker 50.

Additionally, in an embodiment in which the battery 60 is placed on a rear surface of a head of a user, the inner wire accommodation part 251 accommodates the battery wire 40W connecting the battery 60 to an electrical and electronic device placed on the body 10.

The inner temple 21 has a side wall hole connected in communication with the inner wire accommodation part 251.

The side wall hole is disposed in the side wall 2121 in a front end portion of the inner temple 21. The side wall hole disposed in the side wall 2121 in the front end portion of the inner temple 21 is referred to as the ‘front side wall hole 2121h.’

The front side wall hole 2121h is a passage through which the speaker wire 50W and/or the battery wire 40W each accommodated in the inner wire accommodation part 251 pass. The speaker wire 50W and/or the battery wire 40W pass through the front side wall hole 2121h, and then, are connected to an electric and electronic device placed in the body 10.

The front side wall hole 2121h may be configured as a through hole in the side wall 2121 in a front end portion of the inner temple 21.

Alternatively, the front side wall hole 2121h may be configured as a groove recessed on an upper surface disposed on the side wall 2121 in a front end portion of the inner temple 21. The groove may be surrounded by an upper surface of the side wall 2221 in a front end portion of the outer temple 22, which will be described later, to become a through hole (in this embodiment, a groove is not present on the upper surface of the side wall 2221 in the front end portion of the outer temple 22).

Alternatively, the groove may be connected (combined) with the front side wall hole 2221h of the outer temple 22, which will be described later, to become a through hole. In detail, the groove may be connected (combined) with the groove 2221h recessed on an upper surface disposed on the side wall 2221 in a front end portion of the outer temple 22 to become a through hole (for example, a circular, oval, or polygonal through hole).

Additionally, in an embodiment in which the battery 60 is placed on a rear surface of a head of a user, a side wall hole is also disposed in the side wall 2122 in a rear end portion of the inner temple 21. The side wall hole disposed in the side wall 2122 in a rear end portion of the inner temple 21 is referred to as the ‘rear side wall hole 2122h.’

The rear side wall hole 2122h is a passage through which the battery wire 40W and/or other wires each accommodated in the inner wire accommodation part 251 pass. The battery wire 40W and/or the other wires pass through the rear side wall hole 2122h, and then, are connected to the battery 60 located on a rear surface of the head.

The rear side wall hole 2122h may be configured as a through hole in the side wall 2122 in a rear end portion of the inner temple 21.

Alternatively, the rear side wall hole 2122h may be configured as a groove recessed on an upper surface of on the side wall 2122 in a rear end portion of the inner temple 21. The groove may be surrounded by an upper surface of the side wall 2222 in a rear end portion of the outer temple 22, which will be described later, to become a through hole (in this embodiment, a groove is not present on the upper surface of the side wall 2222 in the rear end portion of the outer temple 22).

Alternatively, the groove may be connected (combined) with the rear side wall hole 2222h of the outer temple 22 to become a through hole. In detail, the groove may be connected (combined) with the groove 2222h recessed on an upper surface disposed on the side wall 2222 in a rear end portion of the outer temple 22 to become a through hole (for example, a circular, oval, or polygonal through hole).

Meanwhile, the outer temple 22 includes the outer sound pressure conduit part 242 and the outer wire accommodation part 252 disposed to correspond to the inner sound pressure conduit part 241 and the inner wire accommodation part 251 of the inner temple 21 described above, respectively.

In detail, the outer temple 22 includes the outer sound pressure conduit part 242 and the outer wire accommodation part 252 disposed in positions corresponding to and/or shapes corresponding to the inner sound pressure conduit part 241 and the inner wire accommodation part 251 of the inner temple 21, respectively.

The outer temple 22 includes the base 221 with a plate shape having a preset length in one direction (a first direction) and the side wall 222 protruding in a thickness direction along an edge of the base 221.

The base 221 and the side wall 222 of the outer temple 22 are disposed to correspond to the base 211 and the side wall 212 of the inner temple 21 described above, respectively.

In detail, the base 221 and the side wall 222 of the outer temple 22 are disposed in positions corresponding to and/or shapes corresponding to the base 211 and the side wall 212 of the inner temple 21 described above, respectively.

The side wall 222 of the outer temple 22 extends from an edge of the base 221 in a direction perpendicular to the base 221 and is disposed along the edge of the base 221.

Accordingly, the outer temple 22 has an inner space surrounded by the side wall 222 and having one open side.

When the outer temple 22 and the inner temple 21 are in surface contact to be combined with each other in a thickness direction, the side wall 222 of the outer temple 22 comes into surface contact with the side wall 212 of the inner temple 21. In detail, an upper surface of the side wall 222 of the outer temple 22 and an upper surface of the side wall 212 of the inner temple 21 are in surface contact with each other.

Accordingly, due to the combination of the outer temple 22 and the inner temple 21, the temple has a closed inner space surrounded by the base 221 and the side wall 222 of the outer temple 22 and the base 211 and the side wall 212 of the inner temple 21.

The outer temple 22 and the inner temple 21 may be engaged with each other, for example, by a forced-fit method.

The outer temple 22 has the coupling protruding part 2225, and the inner temple 21 has the coupling groove 2125 engaged with the coupling protruding part 2225. Due to coupling of the coupling protruding part 2225 and the coupling groove 2125, the outer temple 22 and the inner temple 21 are combined to be in surface contact with each other in a thickness direction.

In detail, on the side wall 222 of the outer temple 22, the coupling protruding part 2225 protruding in a direction toward the inner temple 21 may be disposed along the side wall 222.

The coupling protruding part 2225 may be disposed as one continuous part seamlessly along the side wall 222, or may be disposed in plurality at regular intervals along the side wall 222.

In addition, the coupling groove 2125 into which the coupling protruding part 2225 of the outer temple 22 is forced-fit may be disposed on the side wall 212 of the inner temple 21 as one continuous part seamlessly or in plurality at regular intervals. The coupling protruding part 2225 and the coupling groove 2125 are disposed at positions corresponding to each other.

The coupling protruding part 2225 of the outer temple 22 is forced-fit into the coupling groove 2125 of the inner temple 21. At this time, an upper surface of the side wall 222 of the outer temple 22 and an upper surface of the side wall 212 of the inner temple 21 are in surface contact with each other. Due to the forced fitting, the outer temple 22 and the inner temple 21 are not easily separated from each other.

Alternatively, unlike the embodiment described above, the coupling protruding part 2225 of the outer temple 22 may be disposed on the inner temple 21, and the coupling groove 2125 of the inner temple 21 may be disposed on the outer temple 22 to cause the outer temple 22 and the inner temple 21 to be in surface contact to be combined with each other in a thickness direction.

The outer temple 22 and the inner temple 21 may be combined with each other using various engagement methods such as a hook coupling method, in addition to the forced-fit method described above.

Meanwhile, the outer temple 22 has the inner partition wall 223 protruding from an inner surface of the base 221 and configured to have a preset length.

The inner partition wall 223 of the outer temple 22 is disposed to correspond to the inner partition wall 213 of the inner temple 21 described above.

In detail, the inner partition wall 223 of the outer temple 22 is disposed in a position and/or a shape, respectively, corresponding to the inner partition wall 213 of the inner temple 21 described above.

In more detail, the inner partition wall 223 of the outer temple 22 is configured to have a preset length from the side wall 2222 in a rear end portion of the outer temple 22 in a direction toward a front end portion of the outer temple 22, and connected to the lower wall 2224 of the outer temple 22. The inner partition wall 223 may have one or more bent shapes.

The inner partition wall 223 of the outer temple 22 is disposed to extend or protrude in a direction perpendicular to an inner surface of the base 221 (or in a thickness direction of the temple 20). A height of the inner partition wall 223 may be identical to or different from a height of the side wall 222 of the outer temple 22.

When the outer temple 22 and the inner temple 21 are in surface contact to be combined with each other in a thickness direction, the inner partition wall 223 of the outer temple 22 comes into surface contact with the inner partition wall 213 of the inner temple 21. A height of the inner partition wall 223 of the outer temple 22 may be identical to or different from a height of the inner partition wall 213 of the inner temple 21. For example, when a height of the inner partition wall 223 of the outer temple 22 is configured to be great, a height of the inner partition wall 213 of the inner temple 21 is configured to be relatively small. In addition, when a height of the inner partition wall 223 of the outer temple 22 is configured to be small, a height of the inner partition wall 213 of the inner temple 21 is configured to be relatively great. Thus, the sound pressure conduit part 24 and the wire accommodation part 25 of the temple 20 are partitioned from each other to have the inner partition wall 213 therebetween.

The outer sound pressure conduit part 242 is a type of a space (an inner space) surrounded by the side wall 2222 in a rear end portion of the outer temple 22, the inner partition wall 223, and the lower wall 2224. Sound output from the speaker 50 is delivered to outside of the temple 20 through the outer sound pressure conduit part 242 and the speaker hole 214 to be described later.

The outer temple 22 has the speaker hole 214 connected in communication with the outer sound pressure conduit part 242.

The speaker hole 2142 of the outer temple 22 is disposed on the lower wall 2224 of the outer temple 22. In addition, the speaker hole 2142 is disposed in the temple 20 to be in front of an ear.

In detail, when a user wears the face-mounted display device on a head, the speaker hole 2142 is located in front of an ear and disposed on the lower wall 2224 of the outer temple 22 adjacent to the ear. Accordingly, the user may clearly hear sound delivered through the speaker hole 2142 located in front of the ear.

The speaker hole 2142 of the outer temple 22 may be configured as a through hole in the lower wall 2224 of the outer temple 22. Alternatively, the speaker hole 214 of the outer temple 22 may be disposed as a groove recessed on an upper surface of the lower wall 2224 of the outer temple 22. The groove may be surrounded by an upper surface of the lower wall 2124 of the inner temple 21 described above to become a through hole (in this embodiment, a groove is not present on the upper surface of the lower wall 2124 of the inner temple 21). Alternatively, the groove may be connected (combined) with a groove recessed on an upper surface disposed on the lower wall 2124 of the inner temple 21 to become a through hole.

The outer sound pressure conduit part 242 is partitioned from the outer wire accommodation part 252 to be described later by the inner partition wall 213, inside the outer temple 22 surrounded by the side wall 222 of the outer temple 22.

The outer wire accommodation part 252 corresponds to a region in the outer temple 22, other than the outer sound pressure conduit part 242.

In detail, the outer wire accommodation part 252 is a type of a space (an inner space) surrounded by the side wall 2222 in a rear end portion of the outer temple 22, the inner partition wall 223, the lower wall 2224, the side wall 2221 in a front end portion, and the upper wall 2223. Here, the side wall 2222 in a rear end portion of the outer temple 22 indicates a portion of the side wall 2222 in a rear end portion of the outer temple 22, other than the side wall 2222 in a rear end portion of the outer temple 22 constituting the outer sound pressure conduit part 242. In addition, the lower wall 2224 of the outer temple 22 indicates a portion of the lower wall 2224 of the outer temple 22, other than the lower wall 2224 of the outer temple 22 constituting the outer sound pressure conduit part 242.

Accordingly, the outer wire accommodation part 252 is partitioned from the outer sound pressure conduit part 242 described above by the inner partition wall 213, inside the outer temple 22 surrounded by the side wall 222 of the outer temple 22.

The outer wire accommodation part 252 accommodates the speaker wire 50W connected to the speaker 50.

Additionally, in an embodiment in which the battery 60 is placed on a rear surface of a head of a user, the outer wire accommodation part 252 accommodates the battery wire 40W connecting the battery 60 to an electrical and electronic device placed on the body 10.

The outer temple 22 has a side wall hole connected in communication with the outer wire accommodation part 252.

The side wall hole of the outer temple 22 is disposed in the side wall 2221 in a front end portion of the outer temple 22. The side wall hole disposed in the side wall 2221 in the front end portion of the outer temple 22 is referred to as the ‘front side wall hole 2221h.’

The front side wall hole 2221h of the outer temple 22 is a passage through which the speaker wire 50W and/or the battery wire 40W each accommodated in the outer wire accommodation part 252 pass. The speaker wire 50W and/or the battery wire 40W pass through the front side wall hole 2221h of the outer temple 22, and then, are connected to an electric and electronic device placed in the body 10.

The front side wall hole 2221h of the outer temple 22 may be configured as a through hole in the side wall 2221 in a front end portion of the outer temple 22.

Alternatively, the front side wall hole 2221h of the outer temple 22 may be configured as a groove recessed on an upper surface of the side wall 2221 in a front end portion of the outer temple 22. The groove may be surrounded by an upper surface of the side wall 2121 in a front end portion of the inner temple 21 described above to become a through hole (in this embodiment, a groove is not present on the upper surface of the side wall 2121 in the front end portion of the inner temple 21).

Alternatively, the groove may be connected (combined) with the rear side wall hole 2121h of the inner temple 21 to become a through hole. In detail, the groove may be connected (combined) with the groove 2121h recessed on an upper surface disposed on the side wall 2121 in a front end portion of the inner temple 21 to become a through hole (for example, a circular, oval, or polygonal through hole).

Additionally, in an embodiment in which the battery 60 is placed on a rear surface of a head of a user, a side wall hole of the outer temple 22 is also disposed in the side wall 2222 in a rear end portion of the outer temple 22. The side wall hole disposed in the side wall 2222 in the rear end portion of the outer temple 22 is referred to as the ‘rear side wall hole 2222h.’

The rear side wall hole 2222h of the outer temple 22 is a passage through which the battery wire 40W and/or other wires each accommodated in the outer wire accommodation part 252 pass. The battery wire 40W and/or the other wires pass through the rear side wall hole 2222h of the outer temple 22, and then, are connected to the battery 60 disposed on a rear surface of the head.

The rear side wall hole 2222h of the outer temple 22 may be configured as a through hole in the side wall 2222 in a rear end portion of the outer temple 22.

Alternatively, the rear side wall hole 2222h of the outer temple 22 may be configured as a groove recessed on an upper surface of the side wall 2222 in a rear end portion of the outer temple 22. The groove may be surrounded by an upper surface of the side wall 2122 in a rear end portion of the inner temple 21 described above to become a through hole (in this embodiment, a groove is not present on the upper surface of the side wall 2122 in the rear end portion of the inner temple 21).

Alternatively, the groove may be connected (combined) with the rear side wall hole 2122h of the inner temple 21 to become a through hole. In detail, the groove may be connected (combined) with the groove 2122h recessed on an upper surface disposed on the side wall 2122 in a rear end portion of the inner temple 21 to become a through hole (for example, a circular, oval, or polygonal through hole).

In addition, the outer temple 22 includes the speaker accommodation part 225 disposed on an outer surface thereof, the speaker accommodation part hole 226 disposed through the speaker accommodation part 225, and a back volume hole 227 disposed through a position spaced apart from the speaker accommodation part 225 by a preset distance.

The outer sound pressure conduit part 242 and the outer wire accommodation part 252 each described above and located on the outer temple 22 are disposed on an inner surface (an inner side) of the outer temple 22, and the speaker accommodation part 225 and the speaker accommodation part hole 226 are disposed on an outer surface (an outer side) of the outer temple 22.

The speaker accommodation part 225 accommodates a speaker.

The speaker accommodation part 225 is disposed at a position adjacent to a rear end portion of the outer temple 22. Accordingly, the speaker accommodation part 225 and the speaker 50 are placed at a rear of an ear of the user.

In addition, the speaker accommodation part 225 is disposed in the outer sound pressure conduit part 242 disposed on an inner surface (an inner side) of the outer temple 22. In other words, the speaker accommodation part 225 is disposed on an outer surface (an outer side) of the outer temple 22, and disposed on the outer sound pressure conduit part 242 when viewed from an inner surface of the outer temple 22.

However, the speaker accommodation part 225 is not limited to a particular shape. The speaker accommodation part 225 may be configured in various shapes in which the speaker 50 may be seated. For example, as illustrated in FIG. 12, the speaker accommodation part 225 may be configured as a groove configured in a preset depth and having the speaker 50 accommodated therein.

The speaker accommodation part 225 is connected in communication with the outer sound pressure conduit part 242 through the speaker accommodation part hole 226.

The speaker accommodation part hole 226 is disposed in the speaker accommodation part 225.

The speaker accommodation part hole 226 is a through hole penetrating through the outer temple 22 and connected in communication with the outer sound pressure conduit part 242.

In the outer sound pressure conduit part 242, the speaker accommodation part hole 226 is located at a rear of an ear of the user, and the speaker hole 214 is located in front of the ear of the user.

The speaker accommodation part hole 226, the sound pressure conduit part 24, and the speaker hole 214 are connected to each other. Here, the sound pressure conduit part 24 is a passage when the inner sound pressure conduit part 241 is combined with the outer sound pressure conduit part 242. In addition, the speaker hole 214 refers to speaker holes 214 disposed in the inner sound pressure conduit part 241 and/or the outer sound pressure conduit part 242, respectively, or refers to a speaker hole 214 constituted by combining speaker holes 214 disposed in the inner sound pressure conduit part 241 and the outer sound pressure conduit part 242, respectively.

When the speaker 50 is accommodated in the speaker accommodation part 225, a front surface of the speaker 50 from which sound is emitted is directed toward the speaker accommodation part hole 226. Accordingly, the sound emitted from the speaker 50 is delivered to outside of the temple 20 through the speaker accommodation part hole 226, the sound pressure conduit part 24, and the speaker hole 214. At this time, the user may clearly hear the sound delivered through the speaker hole 214 located in front of the ear.

The back volume hole 227 is disposed to be apart from the speaker accommodation part 225 by a preset distance.

The back volume hole 227 in the present disclosure functions to expand back volume of the face-mounted display device. That is, the back volume of the face-mounted display device is expanded through the back volume hole 227.

The back volume hole 227 is a through hole penetrating through the outer temple 22 and connected in communication with the outer wire accommodation part 252. Accordingly, the outer wire accommodation part 252 performs a function of back volume. Additionally, the back volume hole 227 may function as a passage through which the speaker wire 50W connected to the speaker 50 passes.

The wire accommodation part 25 of the temple 20 constituted by combining the outer wire accommodation part 252 of the outer temple 22 and the inner wire accommodation part 251 of the inner temple 21 performs a function of back volume. Accordingly, an effect of expanding the back volume through the back volume hole 227 is obtained.

The back volume hole 227 is disposed at a position adjacent to the speaker accommodation part 225.

The back volume hole 227 is disposed through the outer wire accommodation part 252 disposed on an inner surface of the outer temple 22. Accordingly, volume of a rear space in the speaker 50 placed in the speaker accommodation part 225 is expanded to the wire accommodation part 25 through the back volume hole 227.

A shape of the back volume hole 227 is not limited to a particular shape, and may be configured in a circular, oval, or polygonal shape, etc.

The face-mounted display device according to one embodiment of the present disclosure includes the speaker cover 23.

The speaker cover 23 is engaged with outside of the outer temple 22 and covers the speaker 50.

In detail, the speaker cover 23 covers the speaker accommodation part 225 and the back volume hole 227.

The speaker cover 23 may be engaged with the outer temple 22 using a forced-fit method.

In detail, at an edge of the speaker cover 23, a protruding part protruding toward the speaker accommodation part 225 may be disposed along the edge.

In addition, on an outer surface (an outer side) of the outer temple 22, a groove into which the protruding part of the speaker cover 23 is forced-fit is disposed at an edge to which the speaker cover 23 is coupled. Here, a portion of the edge to which the speaker cover 23 is coupled indicates an edge of the outer temple 22 at which the speaker accommodation part 225 and the back volume hole 227 are disposed.

The protruding part of the speaker cover 23 is forced-fit into the groove of the outer temple 22. At this time, an inner surface of the protruding part of the speaker cover 23 and a side surface of the groove of the outer temple 22 come into contact with each other by the forced-fitting. Due to the forced-fitting, the speaker cover 23 is not easily separated from the outer temple 22.

A shape of the speaker cover 23 is not limited to a particular shape. When the speaker cover 23 is capable of covering the speaker accommodation part 225 and the back volume hole 227, the speaker cover 23 may be configured in various shapes.

### Third Embodiment of the Temple

FIGS. 13 to 16 illustrate a third embodiment of a temple included in a face-mounted display device according to still another embodiment of the present disclosure.

Referring back to FIGS. 13 to 16, the temple 20 according to still another embodiment of the present disclosure includes the first section 20a disposed to extend in one direction (a first direction) and the second section 20b disposed to extend from the first section 20a.

In other words, the temple 20 is constituted by the first section 20a extending in one direction (the first direction) and the second section 20b extending from the first section 20a in a direction (the second direction) other than the one direction (the first direction).

A width of the first section 20a is configured to be smaller than a width of the second section 20b. Here, the width of the first section 20a is a length of the first section 20a in a direction perpendicular to the first direction, and the width of the second section 20b is a length of the second section 20b in a direction perpendicular to the second direction. Since the width of the first section 20a is configured to be smaller than the width of the second section 20b, an effect of reducing a weight of the temple is obtained.

As described above, the temple includes the inner temple 21 and the outer temple 22. Accordingly, the inner temple 21 and the outer temple 22 are respectively configured to include the first section 20a and the second section 20b.

The first section 20a is located between the body 10 and the second section 20b.

The first section 20a is connected to the body 10. A front end portion of the first section 20a corresponds to a front end portion of the temple connected to the body 10. Additionally, a rear end portion of the second section 20b corresponds to a rear end portion of the temple placed at a rear of an ear of a user.

The first section 20a is configured to have a preset length in one direction (the first direction).

For example, the first section 20a is configured to have a rod shape with a preset length in one direction. Alternatively, the first section 20a is configured to have a linear shape with a preset length in one direction. The linear shape includes a straight-line shape or a curved-line shape close to a straight line.

The second section 20b extends from an end portion of the first section 20a. In detail, the second section 20b extends from the end portion of the first section 20a in a second direction intersecting with the first direction of the first section 20a.

An angle between a longitudinal central axial line of the first section 20a (a central axial line extending in the first direction) and a longitudinal central axial line of the second section 20b (a central axial line extending in the second direction) defines an acute angle.

An extension direction (the second direction) of the second section 20b is gradually inclined at a preset angle and directed toward a lower portion of a head. In detail, the second section 20b is gradually inclined from a portion (a boundary region) connected to the first section 20a and extends in a direction toward a lower portion of the head of the user.

Accordingly, a rear end portion of the second section 20b wraps around an ear of the user. Thus, the face-mounted display device is not easily separated from the head. In detail, when the temple is to be separated in a forward direction, a rear end portion of the second section 20b gets caught on a rear surface of the ear, thus restricting the temple from being separated in a forward direction by the second section 20b.

The inner temple 21 includes an inner base having a plate shape and configured as the first section 21a and the second section 21b, and a coupling groove 2129 concave in a thickness direction along an edge of the inner base.

In other words, the coupling groove 2129 is disposed concavely in a direction perpendicular to the inner base from an edge of the inner base, and located along the edge of the inner base. A coupling protruding part 2229 disposed on the outer temple 21, which will be described later, is inserted and forced-fit into the coupling groove 2125.

The sound pressure conduit part 24 is disposed on the inner base to have a groove shape, and has a preset length.

The sound pressure conduit part 24 is formed to have a groove shape in the first section 21a and the second section 21b to be connected in communication with each other.

The sound pressure conduit part 24 disposed in the first section 21a is configured to have a preset length from a boundary region in which the first section 21a is connected to the second section 21b in a direction toward a front end portion of the first section 21a, and bent in a direction toward a lower surface of the inner temple 21 (the first section 21a) to be connected to a lower surface of the inner temple 21 (the first section 21a). Accordingly, the communication hole 2141 of the sound pressure conduit part 24 connected in communication with outside of the temple 20 is disposed on a lower surface of the inner temple 21. The communication hole 2141 is referred to as the ‘speaker hole 214’. Sound output from the speaker 50 is delivered to outside of the temple 20 through the sound pressure conduit part 24 and the speaker hole 214.

The sound pressure conduit part 24 disposed in the second section 21b is configured to have a preset size. The preset size of the sound pressure conduit part 24 may correspond to a size of the speaker.

The sound pressure conduit part 24 disposed in the first section 21a and the sound pressure conduit part 24 disposed in the second section 21b are connected in communication with each other.

The sound pressure conduit part 24 disposed in the first section 21a is configured to have a shape and an area different from those of the sound pressure conduit part 24 disposed in the second section 21b.

A width of the sound pressure conduit part 24 disposed in the first section 21a and a width (a vertical width) of the sound pressure conduit part 24 disposed in the second section 21b are configured differently from each other. In detail, the width of the sound pressure conduit part 24 disposed in the first section 21a is configured to be smaller than the width (the vertical width) of the sound pressure conduit part 24 disposed in the second section 21b. Thus, in the inner temple 21, a width of the first section 21a is configured to be smaller than a width of the second section 21b.

The speaker hole 2141 is disposed on a lower surface of the inner temple 21 (the first section 21a). The speaker hole 214 is disposed in the temple 20 to be in front of the ear.

In detail, when the user wears the face-mounted display device on a head, the speaker hole 2141 is located in front of an ear and disposed on a lower surface of the inner temple 21 (the first section 21a) adjacent to the ear. Accordingly, the user may clearly hear the sound delivered through the speaker hole 214 located in front of the ear.

The wire accommodation part 25 is disposed to be apart from the sound pressure conduit part 24 by a preset distance. Accordingly, the wire accommodation part 25 is partitioned from the sound pressure conduit part 24.

The wire accommodation part 25 is configured in a groove shape on the inner base and disposed from a front end portion of the inner temple 21 (the first section 21a) to a rear end portion of the inner temple 21 (the second section 21b). That is, the wire accommodation part 25 is a groove-shaped passage disposed as one long passage in the first section 21a and the second section 21b of the inner temple 21.

The wire accommodation part 25 is illustrated in FIG. 13 as having a cross-section defined as a constant groove, but is not limited thereto. The wire accommodation part 25 may be disposed to have different cross-sectional areas along a longitudinal direction of the temple, and a groove having a certain size and connected in communication with the wire accommodation part 25 may be additionally disposed on a front end side of the first section 21a. Thus, volume of back volume may be further secured.

The wire accommodation part 25 accommodates the speaker wire 50W connected to the speaker 50.

Additionally, in an embodiment in which the battery 60 is placed on a rear surface of a head of a user, the wire accommodation part 251 accommodates the battery wire 40W connecting the battery 60 to an electrical and electronic device placed on the body 10.

Meanwhile, the outer temple 22 covers the sound pressure conduit part 24 and the wire accommodation part 25 of the inner temple 21 described above.

The outer temple 22 includes an outer base having a plate shape and configured as the first section 22a and the second section 22b, and the coupling protruding part 2229 protruding in a thickness direction along an edge of the outer base.

The outer base of the outer temple 22 has an outer shape corresponding to the inner base of the inner temple 21 to cover the inner base of the inner temple 21 described above.

The coupling protruding part 2229 of the outer temple 22 extends from an edge of the outer base in a direction perpendicular to the outer base and is disposed along an edge of the outer base.

The outer temple 22 and the inner temple 21 may be engaged with each other, for example, by a forced-fit method.

In detail, the coupling protruding part 2229 of the outer temple 22 is forced-fit into the coupling groove 2129 of the inner temple 21.

Due to coupling of the coupling protruding part 2229 of the outer temple 22 and the coupling groove 2129 of the inner temple 21, the outer temple 22 and the inner temple 21 are combined to be in surface contact with each other in a thickness direction.

An inner surface of the coupling protruding part 2229 of the outer temple 22 and a side surface of the coupling groove 2129 of the inner temple 21 come into contact with each other through the forced fitting. Due to the forced fitting, the outer temple 22 and the inner temple 21 are not easily separated from each other.

The outer temple 22 and the inner temple 21 may be combined with each other using various engagement methods, such as a hook coupling method, in addition to the forced-fit method described above.

In addition, the outer temple 22 (the second section 22b) includes the speaker accommodation part 225 disposed on an outer surface thereof, the speaker accommodation part hole 226 disposed through the speaker accommodation part 225, and the back volume hole 227 disposed through a position spaced apart from the speaker accommodation part 225 by a preset distance.

The speaker accommodation part 225 and the speaker accommodation part hole 226 are disposed on an outer surface (an outer side) of the outer temple 22.

The speaker accommodation part 225 accommodates the speaker 50.

The speaker accommodation part 225 is disposed at a position adjacent to a rear end portion of the outer temple 22 (the second section 22b). Accordingly, the speaker accommodation part 225 and the speaker 50 are placed at a rear of an ear of the user.

In addition, the speaker accommodation part 225 is disposed at a position corresponding to the sound pressure conduit part 24 disposed on the inner temple 21 (in detail, the second section 21b).

However, the speaker accommodation part 225 is not limited to a particular shape. The speaker accommodation part 225 may be configured in various shapes in which the speaker 50 may be seated. For example, as illustrated in FIG. 16, the speaker accommodation part 225 may be configured as a groove configured in a preset depth and having the speaker 50 accommodated therein.

The speaker accommodation part 225 is connected in communication with the sound pressure conduit part 242 by the speaker accommodation part hole 226.

The speaker accommodation part hole 226 is disposed in the speaker accommodation part 225.

The speaker accommodation part hole 226 is a through hole penetrating through the outer temple 22 (the second section 22b) and connected in communication with the outer sound pressure conduit part 24 of the inner temple 21 (the second section 21b). Accordingly, sound output from the speaker 50 is delivered to the sound pressure conduit part 24 through the speaker accommodation part hole 226.

The speaker accommodation part hole 226, the sound pressure conduit part 24, and the speaker hole 214 are connected in communication with each other.

When the speaker 50 is accommodated in the speaker accommodation part 225, a front surface of the speaker from which sound is emitted is directed toward the speaker accommodation part hole 226. Accordingly, the sound emitted from the speaker 50 is delivered to outside of the temple 20 through the speaker accommodation part hole 226, the sound pressure conduit part 24, and the speaker hole 214. At this time, the user may clearly hear the sound delivered through the speaker hole 214 located in front of the ear.

The back volume hole 227 is disposed to be apart from the speaker accommodation part 225 by a preset distance.

The back volume hole 227 in the present disclosure functions to expand back volume of the face-mounted display device. That is, the back volume of the face-mounted display device is expanded through the back volume hole 227.

The back volume hole 227 is a through hole penetrating through the outer temple 22 (the second section 22b) and connected in communication with the wire accommodation part 252 of the inner temple 21 (the second section 21b). Accordingly, the wire accommodation part 252 performs a function of back volume. Additionally, the back volume hole 227 may function as a passage through which the speaker wire 50W connected to the speaker 50 passes.

The back volume hole 227 is disposed at a location adjacent to the speaker accommodation part 225 of the outer temple 22 (the second section 22b).

The back volume hole 227 penetrates through the outer temple 22 (the second section 22b) and is disposed at a position corresponding to the wire accommodation part 25 of the inner temple 21 (the second section 21b). Accordingly, volume of a rear space in the speaker 50 placed in the speaker accommodation part 225 is expanded to the wire accommodation part 25 through the back volume hole 227. Additionally, the speaker wire 50W connected to the speaker 50 is accommodated in the wire accommodation part 25 through the back volume hole 227 and electrically connected to an electric and electronic device placed in the body 10.

A shape of the back volume hole 227 is not limited to a particular shape, and may be configured in a circular, oval, or polygonal shape, etc.

The face-mounted display device according to still another embodiment of the present disclosure includes the speaker cover 23.

The speaker cover 23 is engaged with outside of the outer temple 22 (the second section 22b) to cover the speaker 50.

In detail, the speaker cover 23 covers the speaker accommodation part 225 and the back volume hole 227.

The speaker cover 23 may be engaged with the outer temple 22 (the second section 22b) using a forced-fit method.

In detail, at an edge of the speaker cover 23, a protruding part 239 protruding toward the speaker accommodation part 225 is disposed along the edge.

In addition, an extending surface 229 that extends by protruding outward may be disposed on a portion of an outer surface of the outer temple 22 in which the speaker cover 23 is combined. The speaker accommodation part 225 and the back volume hole 227 are disposed on the extending surface 229. A shape of the extending surface 229 and a shape of the speaker cover 23 may correspond to each other.

The speaker cover 23 covers the extending surface 229. The protruding part 239 of the speaker cover 23 is forced-fit into an edge of the extending surface 229 of the outer temple 22. Due to the forced fitting, an inner surface of the protruding part 239 of the speaker cover 23 comes into contact with a side surface of the extending surface 229 of the outer temple 22. Accordingly, the speaker cover 23 is not easily separated from the outer temple 22.

A shape of the speaker cover 23 is not limited to a particular shape. When the speaker cover 23 is capable of covering the speaker accommodation part 225 and the back volume hole 227, the speaker cover 23 may be configured in various shapes.

The face-mounted display device according to the embodiments of the present disclosure described above may further include a temple connection part 40.

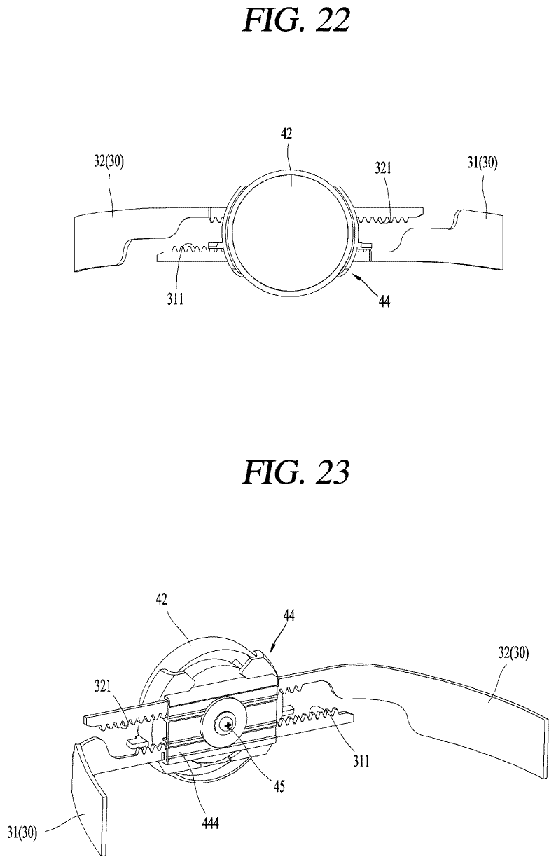

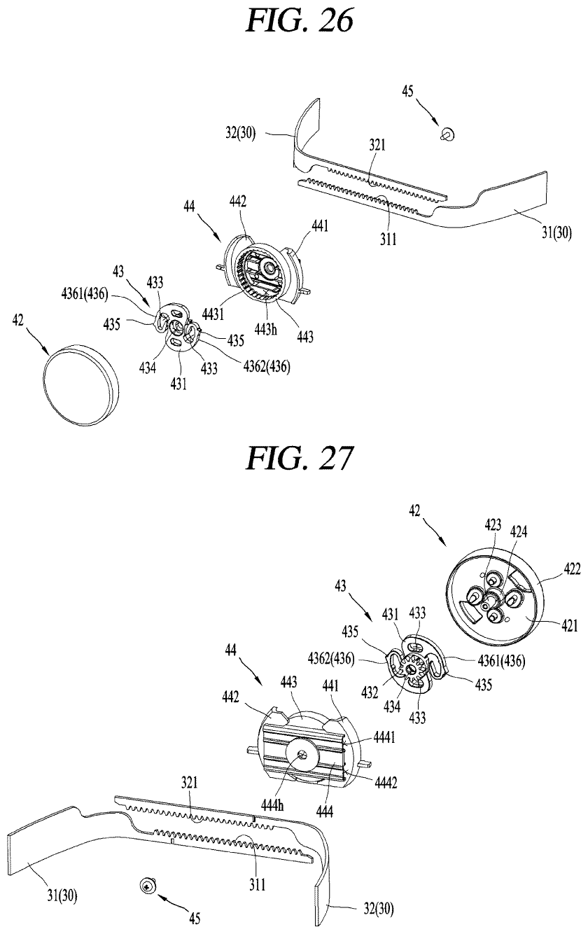

Referring to FIGS. 20 to 27, according to embodiments of the present disclosure, the temple connection part 40 includes a strip 30 connected to the temple 20.

The strip 30 is connected to a rear end portion of the temple 20 which is connected to each of both end portions (or both sides) of the body 10. In detail, one end portion of the strip 30 is connected to a rear end portion of a left temple connected to a left end portion of the body 10, and another end portion of the strip 30 is connected to a rear end portion of a right temple connected to a right end portion of the body 10.

The strip 30 is placed on a rear surface of a head of a user.

The strip 30 has elasticity to elastically support the rear surface of the head.

According to embodiments of the present disclosure, the temple connection part 40 further includes a tension adjustment part configured to adjust tension of the strip 30.

The strip 30 includes a first strip 31 connected to the rear end portion of the right temple connected to the right end portion of the body 10 and a second strip 32 connected to the rear end portion of the left temple connected to the left end portion of the body 10.

One end portion of the first strip 31 is connected to the rear end portion of the right temple, and another end portion of the first strip 31 is connected to the tension adjustment part. A rack tooth part 311 having a preset length is disposed at the another end portion of the first strip 31.

Additionally, one end portion of the second strip 32 is connected to the rear end portion of the left temple, and another end portion of the second strip 32 is connected to the tension adjustment part. A rack tooth part 321 having a preset length is disposed at the another end portion of the second strip 32.

The rack tooth part 311 disposed on the first strip 31 and the rack tooth part 321 disposed on the second strip 32 are arranged to face each other. A pinion 432 of a gear part 43 to be described later is placed between the rack tooth parts 311 and 321 facing each other.

The tension adjustment part includes a rear case 41, a dial 42, a gear part 43, and a gear accommodation part 44.

The rear case 41 includes an inner rear case 412 positioned in a direction toward the head of the user and an outer rear case 411 coupled to the inner rear case 412.

The rear case 41 constitutes an outer appearance of the tension adjustment part.

The rear case 41 is a combination of the inner rear case 412 and the outer rear case 411, and includes an inner space in which the gear part 43 and the gear accommodation part 44 are placed.

The inner rear case 412 and the outer rear case 411 are not limited to a particular shape, and may be configured in various shapes in which the inner space is defined according to the combination.

Each of the inner rear case 412 and the outer rear case 411 has an opening with one side open, and is configured to have a shape of a polygonal container (e.g., a square container).

The opening of the inner rear case 412 and the opening of the outer rear case 411 are arranged to be in contact with each other, thereby defining the inner space.

The inner rear case 412 and the outer rear case 411 may be combined with each other using various methods, such as a hook coupling method, a force-fit method, or a bolting method.

The inner rear case 412 may be seated directly or indirectly on a rear surface of the head of the user. Here, the term, directly means that the inner rear case 412 is in contact with the head. In addition, the term, indirectly means that a contact pad 47 to be described later is placed between the inner rear case 412 and the head. The contact pad 47 comes into contact with the rear surface of the head of the user.

The inner rear case 412 may be configured to be rounded to correspond to the rear surface of the head.

The outer rear case 411 is arranged in an opposite direction to a direction toward the head of the user.

An insertion hole 411h is disposed at a center of the outer rear case 411 to have the dial 42 inserted and placed therein. A shape of the insertion hole 411h corresponds to a shape of the dial 42. Accordingly, when the dial 42 is placed in the insertion hole 411h, inside of the rear case 41 is enclosed not to be viewed through the insertion hole 411h.

Referring to FIG. 20, a strip insertion part into which the strip 30 is inserted and placed may be disposed on both side surfaces of the outer rear case 411.

However, according to an embodiment of the present disclosure, the strip insertion part may be disposed on both side surfaces of the inner rear case 412 (not shown). The strip insertion part is a through hole.

Alternatively, according to an embodiment of the present disclosure, the strip insertion part may be constituted by coupling recesses disposed on the both side surfaces of the inner rear case 412 and recesses disposed on the both sides of the outer rear case 411, respectively, to be in contact with each other.

The dial 42 is inserted and placed into the rear case 41 (in detail, the outer rear case 411).

When the dial 42 is rotated clockwise or counterclockwise by manipulation of the user, the strips 31 and 32 move to a left or right side. Accordingly, tension is applied to or removed from the strips 31 and 32.

The user may apply pressure to the head by manipulating the dial 42 to firmly fix the face-mounted display device to the head, or may remove the pressure from the head to easily remove the face-mounted display device from the head.

Referring to FIG. 27, the dial 42 has a dial body 421 disposed in a circular plate shape and a dial extending part 422 disposed to extend along an edge of the dial body 421. The dial extending part 422 is disposed to be inclined at a preset angle from the dial body 421. The user may adjust tension of the strip 30 by rotating the dial extending part 422.

The dial 42 has a rotary shaft 423 having a pillar shape disposed to protrude from a center portion of an inner surface, and a plurality of catching shafts 424 having a pillar shape disposed to be adjacent to a periphery of the rotary shaft 423 and protrude from an inner surface.

A screw groove is disposed at a center of the rotary shaft 423, and a fastening member (e.g., a fastening screw) 45 is inserted into the screw groove to be fastened.

The gear part 43 is accommodated in the gear accommodation part 44 to be described later and is capable of rotating. In detail, the gear part 43 is accommodated inside a ratchet wheel 443 of the gear accommodation part 44 and capable of rotating inside the ratchet wheel 443.

The gear part 43 has a rotational body 431, pinions 432, a catching shaft hole 433, a rotary shaft hole 434, a ratchet projection support part 436, and a ratchet projection 435.

The rotational body 431 is configured in a plate shape with a constant thickness.

The rotational body 431 has the rotary shaft hole 434 which is a through hole disposed at a center portion, and a catching shaft hole 433 which is a through hole disposed adjacent to a periphery of the rotary shaft hole 434.

The rotary shaft 423 of the dial 42 is inserted and placed into the rotary shaft hole 434, and the catching shafts 424 of the dial 42 are inserted and placed into the catching shaft hole 433. When the user rotates the dial 42, the catching shafts 424 of the dial 42 rotate and come into contact with an inner surface of the catching shaft hole 433 of the rotational body 431 to apply force. Thus, the rotational body 431 rotates together with the dial 42.

The pinion 432 is placed (or disposed) at a center portion of the rotational body 431.

The pinion 432 has a through hole at a center portion and gear teeth disposed in a circumferential direction.

The through hole of the pinion 432 is connected in communication with the rotary shaft hole 434 of the rotational body 431. The rotary shaft 423 of the dial 42 is inserted and placed into the rotary shaft hole 434 of the rotational body 431 and the through hole of the pinion 432.

The pinion 432 engages with the rack tooth parts 311 and 321 disposed on the strip 30. A rotational motion of the pinion 432 is converted into a linear motion of the strip 30.

The pinion 432 may be integrally disposed with the rotational body 431, but is not limited thereto, and may be manufactured separately and coupled to the rotational body 431.

The ratchet projection support part 436 is configured in a cantilever shape extending circumferentially from the rotational body 431.

The ratchet projection support part 436 allows rotation in one direction and does not allow (but limits) rotation in an opposite direction to the one direction.

In detail, the ratchet projection support part 436 has a first latch projection support part 4361 having a cantilever shape and extending circumferentially from one side of the rotational body 431 and a second ratchet projection support part 4362 having a cantilever shape and extending circumferentially from another side of the rotational body 431.

The ratchet projection support part 436 is capable of elastic deformation in a radial direction.

The ratchet projection 435 is disposed to radially protrude from an outermost edge of the ratchet projection support part 436.

The ratchet projection 435 has an approximately triangular cross-section. One surface of the ratchet projection 435 is configured as a guide inclined surface that enables rotation in one direction. Another surface of the ratchet projection 435 is configured as a catching jaw that restricts rotation in an opposite direction to the one direction.

When the gear part 43 rotates in one direction, the guide inclined surface of the ratchet projection 435 may move along a guide surface of the inner tooth part 4431 disposed on the ratchet wheel 443 of the gear accommodation part 44 to be described later. However, when the gear part 43 rotates in an opposite direction to the one direction, a catching jaw of the ratchet projection 435 is caught on a catching surface of the inner tooth part 4431 disposed on the ratchet wheel 443, and thus, cannot move along the catching surface of the inner tooth part 4431.

The gear accommodation part 44 accommodates the gear part 43 and is accommodated in the rear case 41.

The gear accommodation part 44 includes a strip insertion part 444, the ratchet wheel 443, and dial guides 441 and 442.

The strip insertion part 444 is configured to have a polygonal plate shape with a constant thickness and includes a central hole 444h which is a through hole disposed at a center portion thereof. The rotary shaft 423 of the dial 42 is inserted and placed into the center hole 444h.

In a state in which the rotary shaft 423 of the dial 42 is inserted into the center hole 444h of the strip insertion part 444, when the fastening member 45 is inserted and fixed into the screw groove of the rotary shaft 423, the strip insertion part 444 and the dial 42 are fastened (coupled) to each other.

The strip insertion part 444 has an upper strip insertion hole 4441 defined by bending an upper edge, and a lower strip insertion hole 4442 defined by bending a lower edge.

In addition, the strip insertion part 444 has an upper strip guide 4443 disposed at a position spaced apart from the upper edge in a downward direction by a preset distance to extend from an inner surface of the strip insertion part 444, and a lower strip guide 4444 disposed at a position spaced apart from the lower edge in an upward direction by a preset distance to extend from an inner surface of the strip insertion part 444.

The first strip 31 (or the second strip 32) is inserted into the upper strip insertion hole 4441 and guided by the upper strip guide 4443 arranged below. According to rotation of the dial 42, the first strip 31 (or the second strip 32) moves to a left or right side inside the upper strip insertion hole 4441. Accordingly, the first strip 31 (or the second strip 32) applies pressure to or removes pressure from the head of the user.

In addition, the second strip 32 (or the first strip 31) is inserted into the lower strip insertion hole 4442 and guided by the lower strip guide 4444 arranged above. According to rotation of the dial 42, the second strip 32 (or the first strip 31) moves to a left or right side inside the lower strip insertion hole 4442. Accordingly, the second strip 32 (or the first strip 31) applies pressure to or removes pressure from the head of the user.

In a state in which the strips 31 and 32 are inserted into the upper and lower strip insertion holes 4441 and 4442, respectively, when the rack tooth parts 311 and 321 disposed on the first strip 31 and the second strip 32 face each other. The pinion 432 of the gear part 43 is placed between the rack tooth parts 311 and 321 facing each other to be engaged with the rack tooth parts 311 and 321. When the pinion 432 rotates in one direction, the strips 31 and 32 move to a left or right side.

The ratchet wheel 443 is configured to have a circular ring shape and placed at a center portion of the strip insertion part 444.

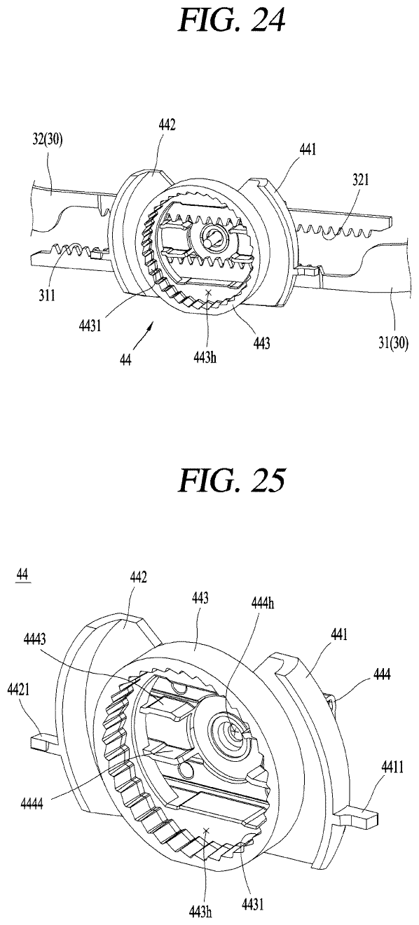

The gear part 43 is accommodated inside the ratchet wheel 443. The gear part 43 is capable of rotating inside the ratchet wheel 443. A reference numeral 443h shown in FIGS. 24 to 26 denotes a through hole of the ratchet wheel 443, and the gear part 43 is accommodated in the through hole 443h.

The dial 42 is seated on the ratchet wheel 443. In detail, when the dial 42 is seated on the ratchet wheel 443, an outer circumferential surface of the ratchet wheel 443 faces an inner circumferential surface of the dial extending part 422 disposed on the dial 42. The dial 42 is capable of rotating in a state of being mounted on the ratchet wheel 443.

The ratchet wheel 443 has the inner tooth part 4431 disposed on an inner circumferential surface.

The inner tooth part 4431 is configured to have an approximately triangular cross-section. The inner tooth part 4431 comes into contact with the ratchet projection 435 of the gear part 43.

The inner tooth part 4431 has a guide surface disposed such that the guide inclined surface of the ratchet projection 435 may move in one direction, and a catching surface disposed such that the catching jaw of the ratchet projection 435 is restricted from moving in an opposite direction to the one direction.

When the gear part 43 rotates in one direction inside the ratchet wheel 443, the guide inclined surface of the ratchet projection 435 disposed on the gear part 43 may move along the guide surface of the inner tooth part 4431 disposed on the gear accommodation part 44. However, when the gear part 43 rotates in an opposite direction to the one direction, the catching jaw of the ratchet projection 435 disposed on the gear part 43 is caught on the catching surface of the inner tooth part 4431 disposed on the gear accommodation part 44. Thus, the ratchet projection 435 of the gear part 43 cannot move along the inner tooth part 4431 of the gear accommodation part 44.

According manipulation by the user, when the dial 42 is rotated in one direction, the gear part 43 rotates in the one direction inside the gear accommodation part 44. In detail, the guide inclined surface of the ratchet projection 435 disposed on the gear part 43 moves in the one direction along the guide surface of the inner tooth part 4431 disposed in the gear accommodation part 44. In accordance with this, the pinion 432 of the gear part 43 rotates in the one direction, causing the strip 30 to move to a left (or right) side. As a result, the strip 30 presses against the head of the user, and the face-mounted display device is firmly fixed to the head of the user.

When the dial 42 stops the rotating in the one direction, elastic force for returning to an original shape or position occurs in the strip 30. When the elastic force is applied or when the user manipulates (applies force to) the dial 42 in the opposite direction to the one direction, the gear part 43 does not rotate in the opposite direction to the one direction inside the gear accommodation part 44. In detail, the catching jaw of the ratchet projection 435 disposed in the gear part 43 is caught on the catching surface of the inner tooth part 4431 disposed in the gear accommodation part 44. Thus, the gear part 43 is restricted from rotating in the opposite direction to the one direction inside the gear accommodation part 44. As a result, the strip 30 continues to press against the head of the user, and the face-mounted display device is kept fixed on the head of the user.

When the user moves the dial 42 in a direction away from a rear surface of the head, the ratchet projection 435 of the gear part 43 is disengaged from the inner tooth part 4431 of the ratchet wheel 443 disposed on the gear accommodation part 44. At this time, the pinion 432 of the gear part 43 is also disengaged from between the rack tooth parts 311 and 321 of the strips 31 and 32. Accordingly, the strip 30 returns to an original shape or position by elastic force, and thus, does not press against the head of the user any more, and the face-mounted display device may be easily removed from the head of the user.

When the user moves the dial 42 in a direction toward the rear surface of the head, the ratchet projection 435 of the gear part 43 returns to the inner tooth part 4431 of the ratchet wheel 443 disposed on the gear accommodation part 44. At this time, the pinion 432 of the gear part 43 is also introduced in between the rack tooth parts 311 and 321 of the strips 31 and 32 to be engaged therewith again. The user may rotate the dial 42 in one direction to secure the face-mounted display device firmly to the head of the user according to pressure by the strip 30.

The dial guides 441 and 442 are placed on both sides of the strip insertion part 444 to have the ratchet wheel 443 therebetween.

The dial guides 441 and 442 support the dial 42 and guide rotation of the dial 42.

The dial guides 441 and 442 are configured to have a plate shape with a constant thickness, and an edge on one side is bent to wrap around a part of the dial 42.

The dial guides 441 and 442 have fixed projections 4411 and 4421 disposed to protrude from one end portion.

The fixed projections 4411 and 4421 are inserted into a fixed groove (not shown) disposed inside the rear case 41 (the outer rear case 411 or the inner rear case 412) to cause the gear accommodation part 44 to be fixed to the rear case 41.

Hereinafter, a coupling relationship between the strip 30, and the rear case 41, the dial 42, the gear part 43, and the gear accommodation part 44 in the tension adjustment part each described above is briefly described.

The strip 30 (in detail, the rack tooth parts 311 and 321 of the strips 31 and 32) is inserted into the upper and lower strip insertion holes 4441 and 4442 of the strip insertion part 444 disposed on the gear accommodation part 44.

In addition, the gear part 43 is inserted and accommodated into the through hole 443h of the ratchet wheel 443 disposed on the gear accommodation part 44.

In addition, the dial 42 is rotatably coupled to the gear accommodation part 44. In detail, the dial 42 is rotatably seated on the ratchet wheel 443 of the gear accommodation part 44. At this time, the rotary shaft 423 of the dial 42 is inserted and placed sequentially into the rotary shaft hole 434 of the gear part 43, a through hole of the pinion 432, a through hole 443h of the ratchet wheel 443, and the center hole 444h of the gear accommodation part 44. Here, the center hole 444h of the gear accommodation part 44 specifically represents the center hole 444h of the strip insertion part 444.

In addition, when the fastening member 45 is inserted and fastened into the screw groove of the rotary shaft 423, the strip 30, the dial 42, the gear part 43 and the gear accommodation part 44 are coupled to each other.

In addition, when the gear accommodation part 44 is inserted and fixed into the rear case 41, the temple connection part 40 to which the strip 30 and the tension adjustment part are coupled is disposed.

According to embodiments of the present disclosure, the temple connection part includes the contact pad 47.

The contact pad 47 is placed between the rear case 41 (in detail, the inner rear case 412) and a rear surface of a head.

The contact pad 47 is fixed to an outer surface of the inner rear case 412. A fixing method may be performed by fixing in various method, such as a bolt fastening method or a bonding method using an adhesive.

The contact pad 47 may be made of a material capable of absorbing shock. For example, the contact pad 47 may be made of a material that may easily absorb shock, such as sponge or Styrofoam, but the material is not limited thereto.

According to embodiments of the present disclosure, the temple connection part 40 further includes the battery 60.

By placing the battery 60 on a rear surface of the head of the user, an effect of evenly distributing a weight with the body 10 placed on a face of the head may be obtained.

The battery 60 may be included in the strip 30. In this embodiment, the strip 30 includes a wire accommodation part that accommodates the battery wire 40W electrically connected to the battery 60. The battery wire 40W connected to an electrical terminal of the battery 60 is placed in the wire accommodation part 25 disposed in the strip 30 and the wire accommodation part 25 disposed in the temple 20, and is electrically connected to the electric and electronic device equipped in the body 10.

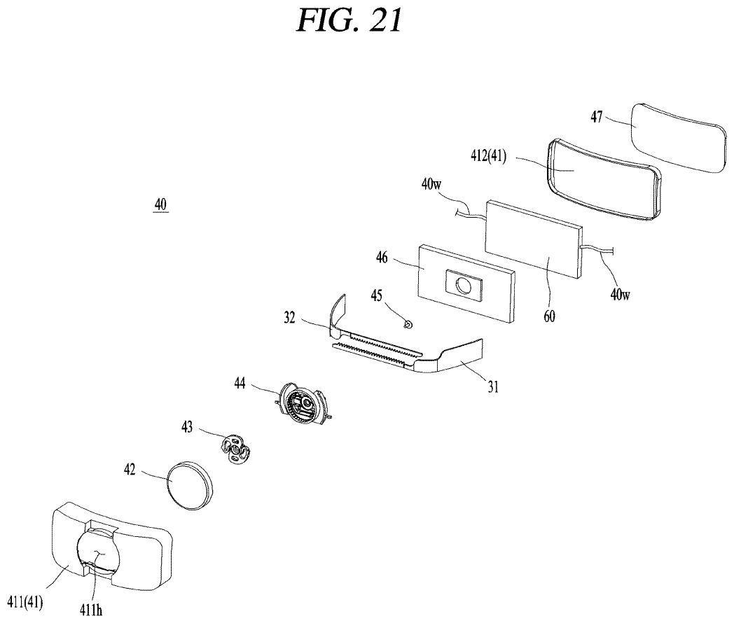

Alternatively, the battery 60 may be placed inside the rear case 41 of the tension adjustment part described above. As shown in FIG. 21, the battery accommodation part 46 is disposed in the rear case 41, and the battery 60 may be placed in the battery accommodation part 46. In this embodiment, the strip 30 includes a wire accommodation part that accommodates the battery wire 40W electrically connected to the battery 60. The battery wire 40W connected to an electrical terminal of the battery 60 is placed on a wire accommodation part disposed on the strip 30 and the wire accommodation part 25 disposed in the temple 20, and electrically connected to the electric and electronic device equipped in the body 10.

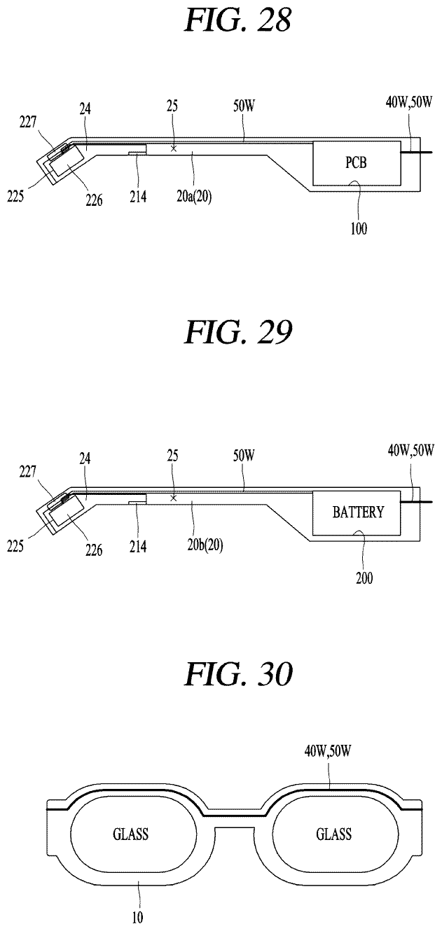

The first embodiment to the third embodiment of the temple 20 described above are also applied to AR Glass illustrated in FIGS. 28 to 30.

The AR glass includes the body 10 including glass placed in front of both eyes of a user and the temple 20 provided on each of both sides of the body 10.

The temple 20 includes the first temple 20a connected to one side of the both sides of the body 10 and a second temple 20b connected to another side of the both sides of the body 10.

As illustrated in FIG. 28, the first temple 20a has a substrate accommodation part 100 that accommodates a display device having a printed circuit board, etc. needed for a display at a front end portion.

Additionally, the first temple 20a has the sound pressure conduit part 24 and the wire accommodation part 25. The sound pressure conduit part 24 and the wire accommodation part 25 are identical or similar to the sound pressure conduit part 24 and the wire accommodation part 25 in the first embodiment to the third embodiment of the temple 20 described above. Therefore, a detailed description about the sound pressure conduit part 24 and the wire accommodation part 25 disposed in the first temple 20a is replaced by the description about the sound pressure conduit part 24 and the wire accommodation part 25 in the first embodiment to the third embodiment of the temple described above. However, the wire accommodation part 25 disposed in the first temple 20a of the AR glass does not accommodate the battery wire 40W and is connected in communicate with the substrate accommodation part 100.

As shown in FIG. 29, in a front end portion of the second temple 20b, a battery accommodation part 200 in which the battery 60 is accommodated is disposed.

Additionally, the second temple 20b includes the sound pressure conduit part 24 and the wire accommodation part 25. The sound pressure conduit part 24 and the wire accommodation part 25 are identical or similar to the sound pressure conduit part 24 and the wire accommodation part 25 in the first embodiment to the third embodiment of the temple described above. Therefore, a detailed description about the sound pressure conduit part 24 and the wire accommodation part 25 disposed in the second temple 20b is replaced by the description about the sound pressure conduit part 24 and the wire accommodation part 25 in the first embodiment to the third embodiment of the temple 20 described above. However, the wire accommodation part 25 disposed in the first temple 20b of the AR glass does not accommodate the battery wire 40W and is connected in communication with the battery accommodation part 200. The speaker wire 50W accommodated in the wire accommodation part 25 is connected to an electric and electronic device equipped in the first temple 20a via the battery accommodation part 200 and the body wire accommodation part disposed in the body 10.

As illustrated in FIG. 30, the body 10 has a body wire accommodation part that accommodates the battery wire 40W electrically connected to the battery 60 and/or the speaker wire 50W electrically connected to the speaker 50.

In the AR glass illustrated in FIGS. 28 to 30, a display method of performing displaying, by a display module, on glass of the body is identical to a display method of displaying on AR glass in the related art. Thus, a detailed description thereof is not provided here.

The face-mounted display device according to the present disclosure has an effect of reducing a size and a weight of a temple by placing a speaker in a rear of the temple.

In addition, an effect of allowing sound output from a speaker to be delivered in front of ears of a user so that the user may clearly and distinctly hear the output sound along with an image is present.

In addition, an effect of expanding volume of back volume by using a wire accommodation part of a temple as back volume is present.

In addition, an effect of capable of distributing a weight of a device in the present disclosure evenly between a front and a rear of a head by placing a display module that outputs an image at the front of the head and a battery that supplies power in the rear of the head is present.

The features, structures, effects, etc. described above in the embodiments are included in at least one embodiment of the present disclosure, but are not limited to only one embodiment. Further, the features, structures, effects, etc. described in respective embodiments may also be combined or modified with respect to other embodiments by those of ordinary skill in the art to which the embodiments pertain. Therefore, content related to such combinations and modifications should be construed as being included in the scope of the present disclosure.

In addition, the foregoing description has been made with reference to the embodiments, but it is merely illustrative and is not intended to limit the present disclosure. It will be apparent that other changes and applications may be made by those skilled in the art to which the present disclosure belong without departing from substantial features of the embodiments of the present disclosure. That is, each component specifically shown in the embodiments may be modified and implemented. Therefore, differences related to such modifications and applications should be construed as being included in the scope of the present disclosure as defined in the appended claims.

1. A face-mounted display device comprising:
a body disposed to correspond to eyes of a user;
a temple having a front end portion connected to the body and a rear end portion disposed at a rear of an ear; and
a speaker equipped in the temple,
wherein the temple comprises a speaker accommodation part disposed to accommodate the speaker in the rear end portion, and a speaker hole spaced apart from the speaker accommodation part by a preset distance and disposed in front of the ear, and
the speaker accommodation part and the speaker hole are connected in communicate with each other.

2. The face-mounted display device of claim 1, wherein the temple comprises a sound pressure conduit part that connects the speaker accommodation part to the speaker hole in communication with each other, and a wire accommodation part partitioned from the sound pressure conduit part.

3. The face-mounted display device of claim 2, wherein the temple comprises an inner temple disposed inside, and an outer temple engaged with the inner temple and disposed outside, and
the sound pressure conduit part and the wire accommodation part are defined and partitioned from each other by combining the inner temple and the outer temple.

4. The face-mounted display device of claim 3, wherein each of the inner temple and the outer temple comprises a first section extending in one direction, and a second section extending from the first section in a direction other than the one direction.

5. The face-mounted display device of claim 4, wherein each of the inner temple and the outer temple comprises a base having a plate shape and configured as the first section and the second section, a side wall protruding along an edge of the base in a thickness direction, and an inner partition wall protruding from an inner surface of the base and configured to have a preset length.

6. The face-mounted display device of claim 5, wherein the sound pressure conduit part is partitioned from the wire accommodation part by the inner partition wall,
the sound pressure conduit part is an inner space surrounded by the inner partition wall and a lower wall of the temple, and
the speaker hole is connected in communication with the sound pressure conduit part, and disposed on a lower wall of the first section.

7. The face-mounted display device of claim 4, wherein the second section of the outer temple comprises the speaker accommodation part disposed on an outer surface, a speaker accommodation part hole disposed through the speaker accommodation part, and a back volume hole disposed through a position spaced apart from the speaker accommodation part by a preset distance,
the speaker accommodation part is connected in communication with the sound pressure conduit part by the speaker accommodation part hole, and
the back volume hole is connected in communication with the wire accommodation part.

8. The face-mounted display device of claim 7, comprising a speaker cover that covers the speaker accommodation part and the back volume hole.

9. The face-mounted display device of claim 3, wherein each of the inner temple and the outer temple comprises a base having a plate shape with a preset length in one direction, a side wall protruding along an edge of the base in a thickness direction, and an inner partition wall protruding from an inner surface of the base and configured to have a preset length.

10. The face-mounted display device of claim 9, wherein the sound pressure conduit part is partitioned from the wire accommodation part by the inner partition wall,
the sound pressure conduit part is an inner space surrounded by a side wall in the rear end portion of the temple, the inner partition wall, and a lower wall of the temple, and
the speaker hole is connected in communication with the sound pressure conduit part, and disposed on the lower wall of the temple.

11. The face-mounted display device of claim 9, wherein the outer temple comprises the speaker accommodation part disposed on an outer surface, a speaker accommodation part hole disposed through the speaker accommodation part, and a back volume hole disposed through a position spaced apart from the speaker accommodation part by a preset distance,
the speaker accommodation part is connected in communication with the sound pressure conduit part by the speaker accommodation part hole, and
the back volume hole is connected in communication with the wire accommodation part.

12. The face-mounted display device of claim 11, comprising a speaker cover that covers the speaker accommodation part and the back volume hole.

13. The face-mounted display device of claim 4, wherein the inner temple comprises an inner base having a plate shape and configured as the first section and the second section, and a coupling groove disposed to be concave in a thickness direction along an edge of the inner base, and
the outer temple comprises an outer base having a plate shape and configured as the first section and the second section, and a coupling protrusion part protruding in a thickness direction along an edge of the outer base and forced-fit into the coupling groove.

14. The face-mounted display device of claim 13, wherein the sound pressure conduit part is formed to be spaced apart from the wire accommodation part by a preset distance,
the sound pressure conduit part is formed to have a groove shape in the first section and the second section of the inner base to be connected in communication with each other,
the wire accommodation part is formed to have a groove shape from a front end portion to a rear end portion of the inner base, and
the speaker hole is connected in communication with the sound pressure conduit part, and formed on a lower surface of the first section.

15. The face-mounted display device of claim 4, wherein the second section of the outer temple comprises the speaker accommodation part disposed on an outer surface, a speaker accommodation part hole disposed through the speaker accommodation part, and a back volume hole disposed through a position spaced apart from the speaker accommodation part by a preset distance,
the speaker accommodation part is connected in communication with the sound pressure conduit part by the speaker accommodation part hole, and
the back volume hole is connected in communication with the wire accommodation part.

16. The face-mounted display device of claim 15, comprising a speaker cover that covers the speaker accommodation part and the back volume hole.

17. The face-mounted display device of claim 1, further comprising a strip fixed to both ends of the temple.

18. The face-mounted display device of claim 17, further comprising a tension adjustment part coupled to the strip to adjust tension of the strip.

19. The face-mounted display device of claim 18, further comprising a battery disposed in the strip or the tension adjustment part.

20. The face-mounted display device of claim 2, wherein the body comprises glass placed in front of both eyes of the user,
the temple comprises a first temple connected to one side among both sides of the body and a second temple connected to another side among the both sides of the body,
the first temple comprises the sound pressure conduit part, the wire accommodation part, and a substrate accommodation part that accommodates a display device on a front end side, and
the second temple comprises the sound pressure conduit part, the wire accommodating part, and a battery accommodation part that accommodates a battery on a front end side.
